(19) United States
(12) Patent Application Publication
(10) Pub. No.: US 2008/0247414 A1
(43) Pub. Date: Oct. 9, 2008

(54) CLOCK STRETCHING IN AN ADAPTIVE TWO-WIRE BUS

(75) Inventors: Stephen J. Sheafor, Boulder, CO (US); Kenneth W. Egan, Austin, TX (US); Gregory T. Chandler, Austin, TX (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: VIZIONWARE, INC., Austin, TX (US)

(21) Appl. No.: 11/695,764

(22) Filed: Apr. 3, 2007

(51) Int. Cl. H04L 12/40

(52) U.S. Cl. 370/438

(57) ABSTRACT

Techniques for improving the quality or fidelity of a digital signal transmitted via a two-wire bus interconnect utilizing an open-terminal configuration at one or both end devices of the bus interconnect are disclosed. An intermediate two-wire bus is used to connect two open-terminal-based two-wire busses. A bus adapter device is utilized at each end of the intermediate two-wire bus, whereby the bus adapter device communicates signaling on the corresponding open-terminal-based two-wire bus using open-terminal ports and communicates signaling on the intermediate two-wire bus using push-pull ports. The bus adapter device can utilize control logic to implement a state machine or other function to control the interactions between the different two-wire buses. The bus adapter devices may be implemented as interchangeable integrated circuit devices that can change configuration based on connection, thereby permitting their implementation at either end of a bus transmission system.

### CROSS-REFERENCE TO RELATED APPLICATIONS

The present application is related to the following applications, the entireties of which are incorporated by reference herein: U.S. patent application Ser. No. ______, (Attorney Docket No. 1009-0021), filed on even date herewith and entitled “Adaptive Two-Wire Bus”; U.S. patent application Ser. No. ______, (Attorney Docket No. 1009-0022), filed on even date herewith and entitled “Data Transaction Direction Detection in an Adaptive Two-Wire Bus”; U.S. patent application Ser. No. ______, (Attorney Docket No. 1009-0023), filed on even date herewith and entitled “Clock Mode Detection in an Adaptive Two-Wire Bus”; and U.S. patent application Ser. No. ______, (Attorney Docket No. 1009-0025), filed on even date herewith and entitled “Cable Assembly Having an Adaptive Two-Wire Bus”.

### BACKGROUND

1. Field of the Invention

The present disclosure relates generally to the communication of digital signals via interconnects, and more particularly to the communication of digital signals via two-wire buses.

2. Description of the Related Art

The proper operation of a digital device typically is dependent on reliable transitions in data signals and clock signals. However, the analog effects exhibited by a digital signal due to device features can cause substantial distortion in the transmitted digital signal, thereby inhibiting the reliability and reach of the transmitted digital signal. Interconnects are a particular source of signal degradation and electromagnetic interference (EMI) due to their particular physical and operational characteristics, such as relatively long signal transmission lengths, paired interconnect length mismatches, and lack of substantial shielding.

Two-wire bus interconnects, such as those based on an Inter-Integrated Circuit (I2C) standard, typically use an open-drain configuration that enables multiple devices to connect directly to the bus without requiring a separate bus arbitration scheme. However, the combination of the resistors used for the open-drain configuration and the parallel arrangement of the two-wires of the bus creates an RC (resistance-capacitance) circuit, which impedes the rise and fall times of edges in the data and clock signals transmitted via the bus and thus reduces the signal fidelity of the data and clock signals. As the length of cables implementing the I2C standard or other two-wire bus standards continues to grow, the signal degradation issues resulting from the analog characteristics of these standards becomes more acute. To illustrate, the Digital Visual Interface (DVI) and High-Definition Multimedia Interconnect (HDMI) standards each utilize the I2C standard for their Display Data Channel (DDC) standard, which is used by a video source device (e.g., a digital video player) to obtain the extended display identification data (EDID) from a video sink device (e.g., a video display). Due to the increasing length of DVI/HDMI cables being implemented and the resulting decrease in signal fidelity, it becomes more likely that the video source device will be unable to obtain accurate EDID from the video sink device, thereby causing the video source device to default to display characteristics (e.g., display resolution) that are of a lower quality than otherwise could be supported by the video sink device. Accordingly, an improved technique for two-wire bus communications would be advantageous.

### BRIEF DESCRIPTION OF THE DRAWINGS

The present disclosure may be better understood, and its numerous objects, features, and advantages made apparent to those skilled in the art by referencing the accompanying drawings. The use of the same reference symbols in different drawings indicates similar or identical items.

FIG. 1 is a block diagram illustrating a data transmission system utilizing a two-wire bus in accordance with at least one embodiment of the present disclosure.

FIG. 2 is a block diagram illustrating an example coupling of bus adapter devices of the data transmission system of FIG. 1 in accordance with at least one embodiment of the present disclosure.

FIG. 3 is a block diagram illustrating an example implementation of a bus adapter device in accordance with at least one embodiment of the present disclosure.

FIG. 4 is a flow diagram illustrating an example operation of a bus adapter device in accordance with at least one embodiment of the present disclosure.

FIG. 5 is a flow diagram illustrating an example method for determining whether a bus adapter device is to initiate data transactions or respond to data transactions in accordance with at least one embodiment of the present disclosure.

FIG. 6 is a flow diagram illustrating an example method for determining whether a source device facilitates clock stretching in accordance with at least one embodiment of the present disclosure.

FIG. 7 is a timing diagram illustrating an example implementation of the method of FIG. 6 in accordance with at least one embodiment of the present disclosure.

FIG. 8 is a flow diagram illustrating an example method for communicating a clock mode indicator from one bus adapter device to another bus adapter device in accordance with at least one embodiment of the present disclosure.

FIG. 9 is a timing diagram illustrating an example implementation of the method of FIG. 8 in accordance with at least one embodiment of the present disclosure.

FIGS. 10 and 11 are flow diagrams illustrating example methods for conducting a data transaction at a master-type bus adapter device in a clock stretching-disabled mode in accordance with at least on embodiment of the present disclosure.

FIG. 12 is a timing diagram illustrating an example implementation of the methods of FIGS. 10 and 11 in accordance with at least one embodiment of the present disclosure.

FIGS. 13 and 14 are flow diagrams illustrating example methods for conducting a data transaction at a slave-type bus adapter device in a clock stretching-disabled mode in accordance with at least on embodiment of the present disclosure.

FIG. 15 is a timing diagram illustrating an example implementation of the methods of FIGS. 13 and 14 in accordance with at least one embodiment of the present disclosure.

FIG. 16 is a diagram illustrating an example state machine operation of bus adapter devices for transmitting data during a write operation in accordance with at least one embodiment of the present disclosure.

FIG. 17 is a timing diagram illustrating an example implementation of the state machine operation of FIG. 16 in accordance with at least one embodiment of the present disclosure.

FIG. 18 is a diagram illustrating an example state machine operation of bus adapter devices for transmitting data during a read operation in accordance with at least one embodiment of the present disclosure.

FIG. 19 is a timing diagram illustrating an example implementation of the state machine operation of FIG. 18 in accordance with at least one embodiment of the present disclosure.

FIG. 20 is a timing diagram illustrating a slave-type bus adapter device initiated communication in accordance with at least one embodiment of the present disclosure.

FIG. 21 is a block diagram illustrating a multimedia transmission system in accordance with at least one embodiment of the present disclosure.

FIG. 22 is a diagram illustrating an example cable assembly implementing a bus adapter device in accordance with at least one embodiment of the present disclosure.

FIG. 23 is a perspective view of the cable assembly of FIG. 22 in accordance with at least one embodiment of the present disclosure.

FIG. 24 is a diagram illustrating an example cable adapter implementing a bus adapter device in accordance with at least one embodiment of the present disclosure.

FIG. 25 is a perspective view of the cable assembly of FIG. 24 in accordance with at least on embodiment of the present disclosure.

### DETAILED DESCRIPTION OF THE PREFERRED EMBODIMENTS

In a first aspect, an apparatus can include a first bus interface including a first open-terminal port coupleable a first line of a first two-wire bus and a second open-terminal port coupleable to a second line of the first two-wire bus. The apparatus can also include a second bus interface including a first push-pull port coupleable to a first line of a second two-wire bus and a second push-pull port coupleable to a second line of the second two-wire bus, and control logic to modify a state of the second line of the first two-wire bus via the second open-terminal port based on handshake information received via the second push-pull port.

In a second aspect, an apparatus can include a first bus interface including a first open-terminal port coupleable a first line of a first two-wire bus and a second open-terminal port coupleable to a second line of the first two-wire bus. The apparatus can also include a second bus interface including a first push-pull port coupleable to a first line of a second two-wire bus and a second push-pull port coupleable to a second line of the second two-wire bus, and control logic to transmit handshake information via the second push-pull port based on clock information received via the second open-terminal port.

In a third aspect, an apparatus can include a first open-terminal port coupled to a first line of a first two-wire bus, a second open-terminal port coupled to a second line of the first two-wire bus, a first push-pull port coupled to a first line of a second two-wire bus, and a second push-pull port coupled to a second line of the second two-wire bus. The apparatus can also include a method modifying a state of the second line of the first two-wire bus via the second open-terminal port based on handshake information received via the second push-pull port.

In a fourth aspect, an apparatus can include a first open-terminal port coupled to a first line of a first two-wire bus, a second open-terminal port coupled to a second line of the first two-wire bus, a first push-pull port coupled to a first line of a second two-wire bus, and a second push-pull port coupled to a second line of the second two-wire bus. The apparatus can also include a method including transmitting handshake information via the second push-pull port based on clock information received via the second open-terminal port.

In a fifth aspect, an apparatus can include a first bus adapter device and a second bus adapter device, the first bus adapter device including a first open-terminal port coupled to a first line of a first two-wire bus, a second open-terminal port coupled to a second line of the first two-wire bus, a first push-pull port coupled to a first line of a second two-wire bus, and a second push-pull port coupled to a second line of the second two-wire bus, and the second bus adapter device including a third open-terminal port coupled to a first line of a third two-wire bus, a fourth open-terminal port coupled to a second line of the third two-wire bus, a third push-pull port coupled to the first line of the second two-wire bus, and a fourth push-pull port coupled to the second line of the second two-wire bus. The apparatus can also include a method including driving, via the fourth open-terminal port, the second line of the third two-wire bus to a first state, transmitting, via the second push-pull port, a first handshake indicator in response to detecting, via the second open-terminal port, a transition of the second line of the first two-wire bus from a first state to a second state, and releasing the second line of the third two-wire bus in response to receiving the first handshake indicator via the fourth push-pull port.

The method can also include transmitting, via the fourth push-pull port, a second handshake indicator in response to detecting, via the fourth open-terminal port, a transition of the second line of the third two-wire bus from the first state to the second state subsequent to releasing the second line of the third two-wire bus, and driving, via the second open-terminal port, the second line of the first two-wire bus to the first state in response to detecting a transition of the second line of the first two-wire bus from the second state to the first state. The method can further include transmitting, via the second push-pull port, a third handshake indicator in response to receiving, via the second push-pull port, the second handshake indicator and in response to detecting, via the second open-terminal port, the second line of the first two-wire bus is at the first state, and driving, via the fourth open-terminal port, the second line of the third two-wire bus to the first state in response to receiving, via the fourth push-pull port, the third handshake indicator. The method can still further include transmitting, via the fourth push-pull port, a fourth handshake indicator in response to a lapse of a predetermined duration subsequent to receiving the third handshake indicator, and releasing the second line of the first two-wire bus in response to receiving, via the second push-pull port, the fourth handshake indicator.

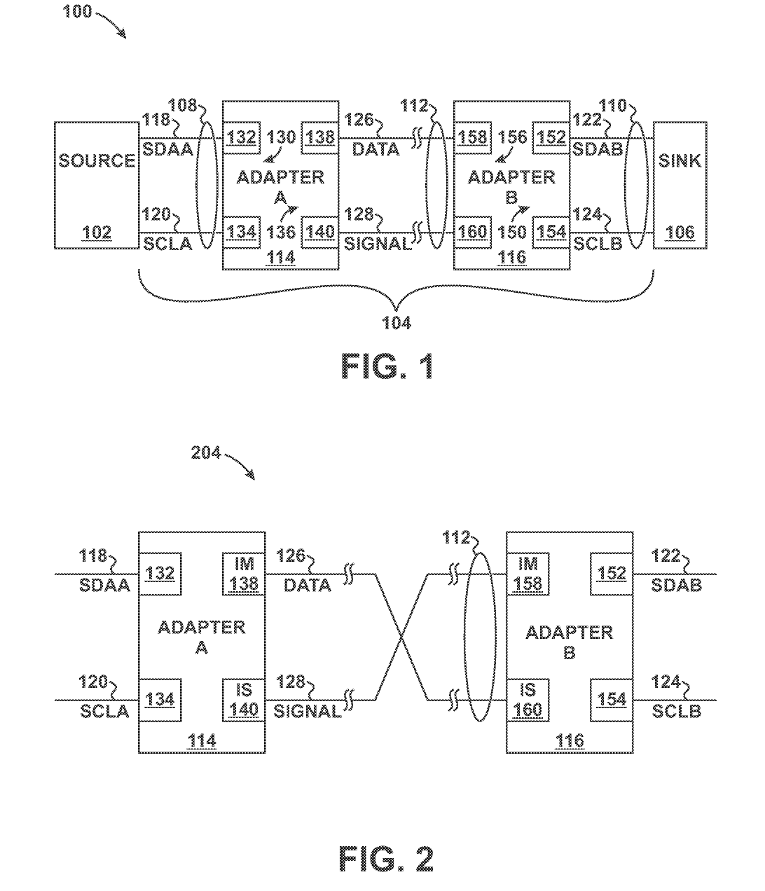

FIGS. 1-25 illustrate techniques for improving the quality or fidelity of a digital signal transmitted via a two-wire bus interconnect utilizing an open-terminal configuration at one or both end devices of the bus interconnect. In at least one embodiment, an intermediate two-wire bus is used to connect two open-terminal-based two-wire busses, such as two I2C-compliant busses. A bus adapter device is utilized at each end of the intermediate two-wire bus, whereby the bus adapter device communicates signaling on the corresponding open-terminal-based two-wire bus using open-terminal ports and communicates signaling on the intermediate two-wire bus using push-pull ports. In at least one embodiment, the bus adapter device utilizes control logic to implement a state machine or other function to control the interactions between the different two-wire buses. The bus adapter devices may be implemented as interchangeable integrated circuit devices that can change configuration based on connection (e.g., either source end or sink end), thereby permitting their implementation at either end of a bus transmission system.

The term “open-terminal,” as used herein, is defined as a configuration whereby one or more resistive elements are used to drive a bus line to one voltage reference and one or more transistors are used to drive the bus line to another voltage reference. The term “push-pull,” as used herein, is defined as a configuration whereby one or more transistors are used to drive a bus line to one voltage reference or logic level and one or more transistors are used to drive the bus line to another voltage reference or logic level. The term “two-wire bus” and its variants, as used herein, refers to a bus that utilizes two conductive lines to communicate information, such as data and clock information. The conductive lines can include electrically conductive lines (e.g., wire interconnects), optically conductive lines (e.g., fiber optic lines), or a combination thereof. A two-wire bus can include voltage reference lines in addition to the two lines used to transmit information. Further, a two-wire bus can be implemented as part of a larger bus scheme, such as a DDC bus in an DVI/HDMI interconnect.

Reference made to driving a line or a signal to particular state comprises either driving the line or signal to the particular state from another state or maintaining the line or signal at a particular state.

The term “cable,” as used herein, is defined as an assembly of two or more conductive (electrically conductive or optically conductive) interconnects in an enveloping sheath and at least one cable receptacle disposed at a corresponding end of the sheath and electrically or optically coupled to at least a subset of the two or more conductive interconnects. The term “cable adapter,” as used herein, is defined as an assembly of a housing and at least two electrically or optically coupled cable receptacles disposed at the housing. The term “cable receptacle,” as used herein, is defined as a receptacle configured to removably electrically or optically couple and removably mechanically couple with a cable interface of a device or with another cable receptacle. The term “cable assembly,” as used herein, refers to either a cable or a cable adapter. The term “active signal management circuitry” and its variants, as used herein, is defined as circuitry implementing one or more transistor devices configured to manipulate a digital signal. The term “active signal management process” and its variants, as used herein, is defined as a manipulation of a digital signal using active signal management circuitry.

For ease of illustration, the techniques disclosed herein are described in the context of an Inter-Integrated Circuit (I2C) standard-based bus configuration. However, it will be appreciated that the disclosed techniques can be implemented in other open-terminal-based bus configurations using the guidelines provided herein without departing from the scope of the present disclosure. Further, the techniques discloses herein also are described in the context of the transmission of high-definition television (HDTV) related signals, and more specifically, the transmission of signaling based on the digital video interface (DVI) and the high-definition multimedia interface (HDMI) standards. However, it will be appreciated that these techniques can be employed in other signaling environments using the guidelines provided herein without departing from the scope of the present disclosure. Examples of other signal transmission formats in which the disclosed techniques can be implemented include, but are not limited to, a Video Electronics Standards Association (VESA) DisplayPort standard, a Unified Display Interface (UDI) standard, a Serial Attached Small Computer System Interface (SAS) standard, a Serial Management Bus (SMB or SMBus) standard and the like.

Referring to FIG. 1, a data transmission system 100 for improving the fidelity or quality of digital signals transmitted via an interconnect is illustrated in accordance with at least one embodiment of the present disclosure. The data transmission system 100 includes a source device 102, a two-wire bus interconnect 104, and a sink device 106. The source device 102 can include any of a variety of devices that source data for transmission via the two-wire bus interconnect 104, such as, for example, a digital video disk (DVD) player, a set top box, a microprocessor, and the like. The sink device 106 can include any of a variety of devices that utilize data transmitted via the two-wire bus interconnect 104, such as, for example, a display device, a peripheral device, and the like. In one embodiment, the source device 102 also can act as a sink device and the sink device 106 also can act as a source device. Further, although FIG. 1 illustrates two devices connected via the two-wire bus interconnect 104, in other embodiments the data transmission system 100 can include more than two devices connected via the two-wire bus interconnects 108 and 110. Further, it will be appreciated that the two-wire bus interconnect 104 can be implemented in a larger bus interconnect between the source device 102 and the sink device 106. To illustrate, the two-wire bus interconnect 104 can include the DDC bus of a DVI or HDMI interconnect between the source device 102 and the sink device 106.

In the depicted example, the two-wire bus interconnect 104 is configured to emulate an I2C-based bus at the source end and sink end of the data transmission system 100. The two-wire bus interconnect 104 includes an I2C bus segment 108 connected to the source device 102, an I2C bus segment 110 connected to the sink device 106, and an intermediate bus segment 112 connected to the I2C bus segment 108 via a bus adapter device 114 (also referred to herein as bus adapter device A) and connected to the I2C bus segment 110 via a bus adapter device 116 (also referred to herein as bus adapter device B). The I2C bus segment 108 comprises a two-wire bus including a serial data (SDA) line 118 (also referred to herein as the SDAA line) connected to a SDA port (not shown) of the source device 102 and a serial clock (SCL) line 120 (also referred to herein as the SCLA line) connected to a SCL port (not shown) of the source device 106. The I2C bus segment 110 comprises a two-wire bus comprising a SDA line 122 (also referred to herein as the SDAB line) connected to a SDA port (not shown) of the sink device 102 and a SCL line 124 (also referred to herein as the SCLB line) connected to a SCL port (not shown) of the sink device 102. The intermediate bus segment 112 includes a data line 126 and a signal line 128. In some embodiments, some or all of the I2C bus segment 108, the I2C bus segment 110, and the intermediate bus segment 112 further may include voltage reference lines, which are omitted from the illustration of FIG. 1 for clarity.

In one embodiment, the bus adapter device 114 includes an I2C interface 130 comprising an open-terminal port 132 connected to the SDA line 118 and an open-terminal port 134 connected to the SCL line 120, and a bus interface 136 comprising a tristateable push-pull port 138 connected to the data line 126 and a tristateable push-pull port 140 connected to the signal line 128. Similarly, the bus adapter device 116 includes an I2C interface 150 comprising an open-terminal port 152 connected to the SDA line 122 and an open-terminal port 154 connected to the SCL line 124, as well as a bus adapter device bus interface 156 comprising a tristateable push-pull port 158 connected to the data line 126 and a tristateable push-pull port 160 connected to the signal line 128.

For purposes of illustration, the source device 102 is considered to be the master for the two-wire bus interconnect 104 and the sink device 106 is considered to be a slave device for the two-wire bus interconnect 104 in the embodiment of FIG. 1. However, in other implementations, the designation of master and slave can change per data transaction. In operation, the data transmission system 100 transmits data and clock information from the source device 102 to the sink device 106 via the two-wire bus interconnect 104, and in some embodiments, transmits data information from the sink device 106 to the source device 102. In one embodiment, the source device 102 and the sink device 106 communicate data information and clock information using signaling based on, or substantially compliant with, the I2C standard via the I2C bus segment 108 and the I2C bus segment 110, respectively. The bus adapter device 114, in one embodiment, is configured to receive the information represented by the open-terminal-based signaling provided by the SDA line 118 and the SCL line 108 via the I2C interface 130 and provide the received information, or a representation thereof, to the bus adapter device 116 via the push-pull-based bus interface 136. Conversely, the bus adapter device 116, in one embodiment, is configured to receive the information provided by the bus adapter device 114 via the bus interface 156 and provide the information to the sink device 106 as open-terminal-based signaling by the SDA line 122 and the SCL line 124 in a form substantially equivalent to the original form of the signaling transmitted by the source device 102. The bus adapter device 116 also can be configured to receive information represented by open-terminal-based signaling provided by the SDA line 122 and the SCL line 124 via the I2C interface 150 and provide the received information, or a representation thereof, to the bus adapter device 114 via the push-pull-based bus interface 156. The bus adapter device 114, in this embodiment, can configured to receive the information provided by the bus adapter device 116 via the bus interface 136 and provide the information to the source device 102 as open-terminal-based signaling by the SDA line 118 and the SCL line 120 in a form substantially equivalent to the original form of the signaling transmitted by the sink device 106.

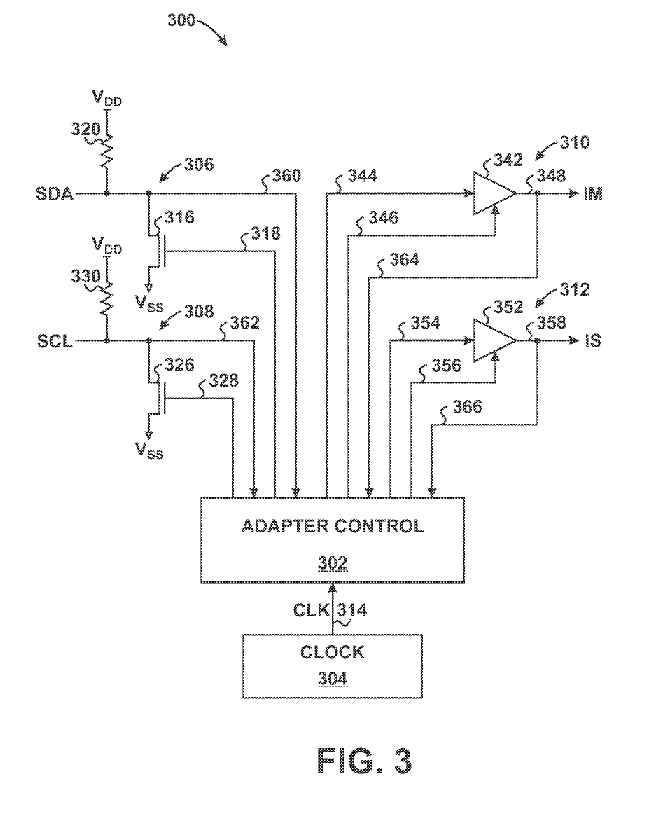

The use of bus adapter devices 114 and 116 to receive information represented by open-terminal-based signaling, transmit the information, or a representation thereof, via the intermediate bus segment 112 using push-pull-based signaling, and then reconverting the information at the receiving end of the intermediate bus segment 112 to be represented by open-terminal-based signaling can improve signal fidelity while permitting compatibility with source and sink devices configured to support an open-terminal-based signaling standard. The improved signal fidelity can enable the use of longer interconnects than otherwise could be supported using open-terminal-based signaling alone. Example techniques for the conversion of open-terminal-based signaling (e.g., I2C-based signaling) to the push-pull-based signaling of the intermediate bus segment 112 is illustrated in greater detail with reference to FIGS. 3-20.

Referring to FIG. 2, an alternate bus interconnect configuration is illustrated in accordance with at least one embodiment of the present disclosure. As with the two-wire bus interconnect 104 of FIG. 1, the two-wire bus interconnect 204 of FIG. 2 includes the bus adapter device 114 connected to the SDA line 118 and the SCL line 120 of the I2C bus segment 108, the tristateable push-pull port 138 (also referred to herein as an Internal Master (IM) port) connected to the data line 126, and the tristateable push-pull port 140 (also referred to herein as an Internal Slave (IS) port) connected to the signal line 128. The bus adapter device 116 is connected to the SDA line 122 and the SCL line 124 of the I2C bus segment 110, the tristateable push pull port 158 connected to the data line 126, and the tristateable port 160 connected to the signal line 126. In at least one embodiment, the bus adapter device 114 and the bus adapter device 116 are the same type of bus adapter device (i.e., interchangeable) so that either can be configured to operate as either a master-type bus adapter device associated with a source device or as a slave-type bus adapter device associated with a sink device. Thus, as the tristateable push-pull ports 138 and 158 are the same push-pull port of the identical device and the tristateable push-pull ports 140 and 160 are the same push-pull port of the identical device, the data line and the signal line 128 can be considered to be cross-coupled between the bus adapter device 114 and the bus adapter device 116 so as to permit either bus adapter device to operate as the master depending on the direction in which the two-wire bus interconnect 204 is connected between the source device 102 (FIG. 1) and the sink device 106 (FIG. 1). The utility of this cross-coupling is described in detail herein.

Referring to FIG. 3, a bus adapter device 300 illustrating an example implementation of either of the bus adapter devices 114 and 116 of FIGS. 1 and 2 is illustrated in accordance with at least one embodiment of the present disclosure. In the depicted example, the bus adapter device 300 includes an adapter control module 302, a clock source 304, an open-terminal port 306 (e.g., open-terminal port 132 of bus adapter device 114 or open-terminal port 152 of bus adapter device 116, FIG. 1), an open-terminal port 308 (e.g., open-terminal port 134 of bus adapter device 114 of open-terminal port 154 of bus adapter device 116, FIG. 1), a tristateable push-pull port 310 (e.g., tristateable push-pull port 138 of bus adapter device 114 or tristateable push-pull port 158 of bus adapter device 116, FIG. 1), and a tristateable push-pull port 312 (e.g., tristateable push-pull port 140 of bus adapter device 114 or tristateable push-pull port 160 of bus adapter device 116, FIG. 1).

The open-terminal port 306 is coupleable to an SDA line (e.g., SDA lines 118 or 122, FIG. 1) of an I2C-type bus and the open-terminal port 308 is coupleable to an SCL line (e.g., SCL lines 120 or 124, FIG. 1) of the I2C-type bus. The open-terminal port 306 includes a pull-down transistor 316 configured to drive the SDA line to a first voltage reference (e.g., Vss) based on a control signal 318 from the adapter control module 302, whereas a resistor 320 is used to pull the SDA line to a second voltage reference (e.g., Vdd). Likewise, the open-terminal port 308 includes a pull-down transistor 326 configured to drive the SCL line to the first voltage reference based on a control signal 328 from the adapter control module 302, whereas a resistor 330 is used to pull the sCL line to the second voltage reference. The resistors 320 and 330 may be implemented at the open-terminal ports 306 and 308, respectively, at the open-terminal ports of the sink/source device, or along the bodies of the SDA and SCL lines. Thus, the bus adapter device 300 operates in two modes with respect to each of the open-terminal ports 306 and 308. In a driving mode, the adapter control module 302 drives a line connected to an open-terminal port to a logic low state (e.g., at or near Vss) by enabling the corresponding pull-down transistor (i.e., turning “on” the pull-down transistor) of the open-terminal port so that the pull-down transistor “pulls” the voltage potential of the line to Vss. Conversely, in a non-driving mode, the adapter control module 302 releases a line connected to an open-terminal port by disabling the corresponding pull-down transistor (i.e., turning “off” the pull-down transistor) so that either the corresponding resistor can “pull” the voltage potential line up a logic high state (e.g., Vdd), or so that another device connected to the line can drive the line to a low logic state. In an alternate embodiment, pull-up transistors and pull-down resistors may be used for the open-terminal ports 306 and 308.

As discussed above, substantially identical bus adapter devices 300 can be utilized at both the source-side and the sink-side of the two-wire bus interconnect 104 and thus the line of the intermediate bus segment 112 coupled to the tristateable push-pull port 310 is identified as the data line 126 (FIGS. 1 and 2) and the line of the intermediate bus segment 112 coupled to the tristateable push-pull port 312 is identified as the signal line 128 (FIGS. 1 and 2) when the bus adapter device 300 is configured as the master-type bus adapter device. Conversely, the line of the intermediate bus segment 112 coupled to the tristateable push-pull port 310 is identified as the signal line 128 and the line of the intermediate bus segment 112 coupled to the tristateable push-pull port 312 is identified as the data line 126 when the bus adapter device 300 is configured as the slave-type bus adapter device. The tristateable push-pull port 310 includes a tristateable buffer 342 comprising an input to receive an information signal 344 from the adapter control module 302 for transmission, a control input to receive a control signal 346 from the adapter control module 302, and an output configured to provide an information signal 348 (representative of the information signal 344) or to provide a high-impedance state based on the state of the control signal 346. Likewise, the tristateable push-pull port 312 includes a tristateable buffer 352 comprising an input to receive an information signal 354 from the adapter control module 302 for transmission, a control input to receive a control signal 356 from the adapter control module 302, and an output configured to provide an information signal 358 (representative of the information signal 354) or to provide a high-impedance state based on the state of the control signal 356.

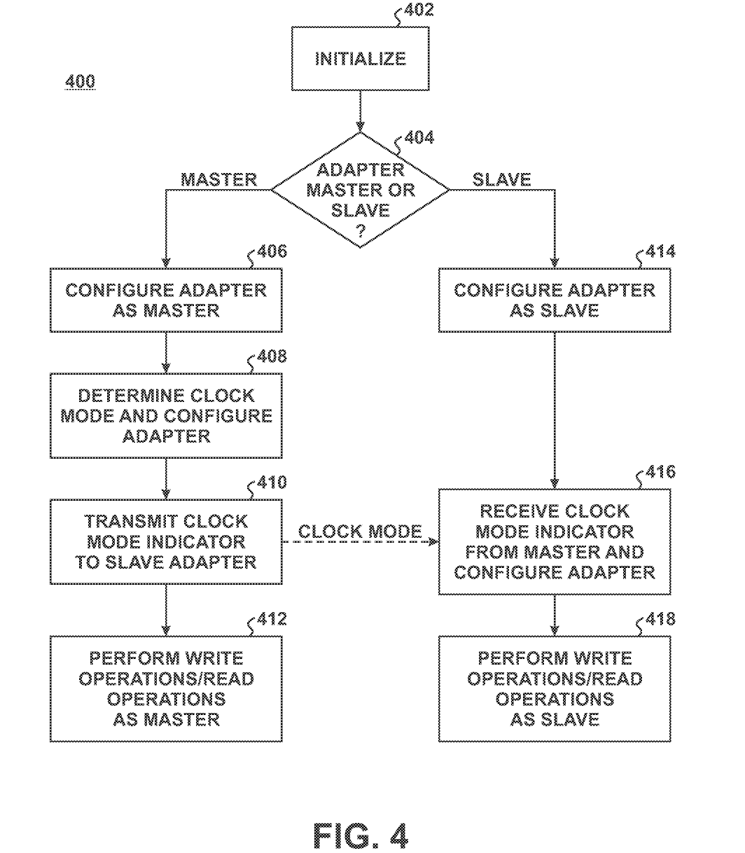

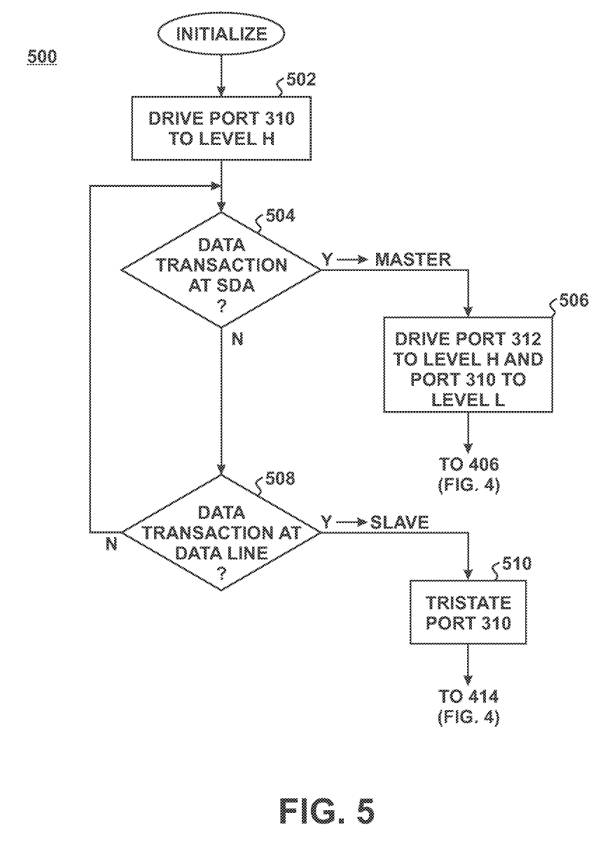

The adapter control module 302, in one embodiment, comprises control logic configured to implement one or more state machines or other functions to manipulate the ports 306, 308, 310, and 312 as described herein. The adapter control module 302 includes inputs to receive signaling 360 and 362 from the SDA line and the SCL line, respectively, inputs to receive signaling 364 from one of the data line 126 and the signal line 128 and an input to receive signaling 366 from the other. The adapter control module 302 further includes outputs to provide the control signals 318, 328, 346, and 356 and data signals 344 and 354. Example operations of the adapter control module 302 is described herein with respect to FIGS. 4-25.

The clock source 304 includes a clock generation circuit (e.g., an oscillator) or other clock source (e.g., a clock tree, a phase-locked loop, etc.) to provide a clock signal 314 for use by the adapter control module 302. In at least one embodiment, the two-wire bus interconnect 104 (FIG. 1) does not require synchronization between the phases and frequencies of the clock signal 314 used by the bus adapter device 114 and the clock signal 314 used at the bus adapter device 116. However, in order to provide a margin between the bus adapter device 114 and the bus adapter device 116, a minimum and maximum frequency can be set for the clock signal 314. The bus adapter device 300 further may implement one or more counters (not shown) to count cycles of the clock signal 314 or other clock signal.

Referring to FIG. 4, an example method 400 of an operation of the bus adapter device 300 of FIG. 3 is illustrated in accordance with at least one embodiment of the present disclosure. Although depicted as a flow diagram in FIG. 4, the method 400, in one embodiment, is implemented as a state machine by the adapter control module 302.

At block 402, an initialization stimulus is received at the bus adapter device 300 and the adapter control module 302 initializes the bus adapter device 300 in response to the initialization stimulus. The initialization stimulus can include, for example, the application of power to the bus adapter device 300 via a voltage reference line of the bus interconnect in which the bus adapter device 300 is implemented. Alternately, the initialization stimulus can include the initiation of a data transaction via the I2C bus segment 108, the I2C bus segment 110, or the intermediate bus segment 112.

At block 404, the bus adapter device 300 determines whether it is associated with a source device, and thus a master-type bus adapter device, or associated with a sink-device, and thus a slave-type bus adapter device. The determination of the bus adapter device 300 as a master-type or a slave-type can be determined on a per-data-transaction basis, or the configuration as master-type or slave-type can be implemented more permanently (e.g., for a succession of data transactions via the two-wire bus interconnect 104). An example technique for making this determination is illustrated herein with reference to FIG. 5.

In response to determining that the bus adapter device 300 is a master-type bus adapter device (for a data transaction or for a series of data transactions), the bus adapter device 300 configures itself as a master-type bus adapter device at block 406. Example configurations and operations of a master-type bus adapter device are described in detail herein.

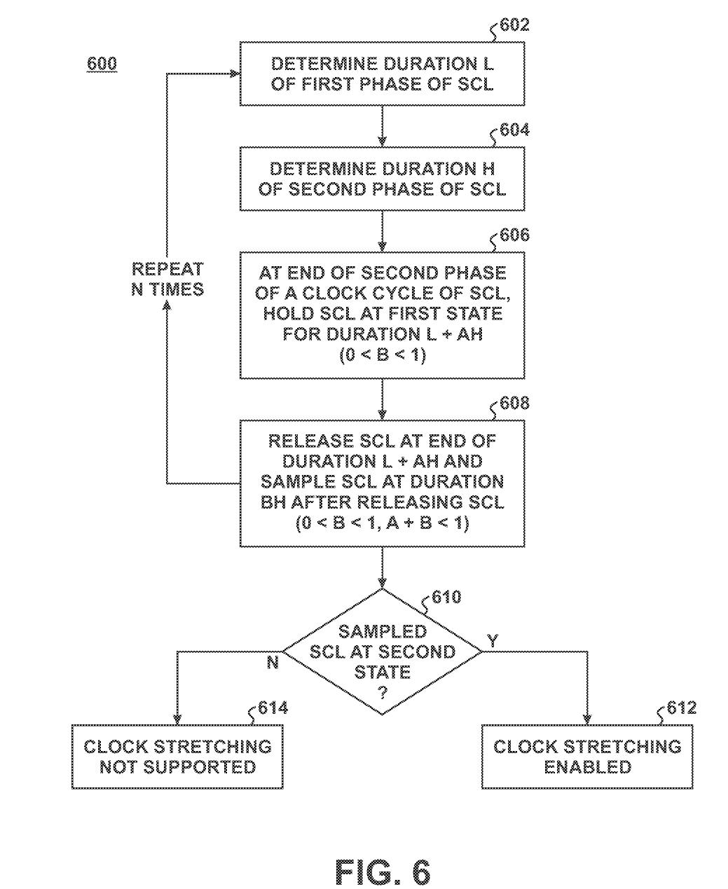

In the I2C standard, the master device typically provides a clock signal via the SCL line of an I2C-type bus. However, because the slave device may need additional time to process incoming write data or to process data in response to a read request, the I2C standard provides for clock stretching (also referred to in the art as synchronization) whereby the slave device can hold the SCL line low until it is ready, at which time the master device continues the clock signal starting at the point at which the slave device pulled the SCL line low. However, some master devices are not enabled to facilitate clock stretching for any of a variety of reasons. Accordingly, at block 408, the bus adapter device 300 determines the clock mode (a clock stretching-enabled mode or a clock stretching-disabled mode) to be implemented by the bus interconnect by determining whether clock stretching is enabled at the source device (as the master device) and the adapter control module 302 configures the bus adapter device 300 to operate in accordance with the determined clock mode. At block 410, the bus adapter device 300 transmits a clock mode indicator to the one or more slave bus adapter devices of the bus interconnect. Example techniques for determining the clock mode and transmitting an indicator of the clock mode are described herein with reference to FIGS. 6-8.

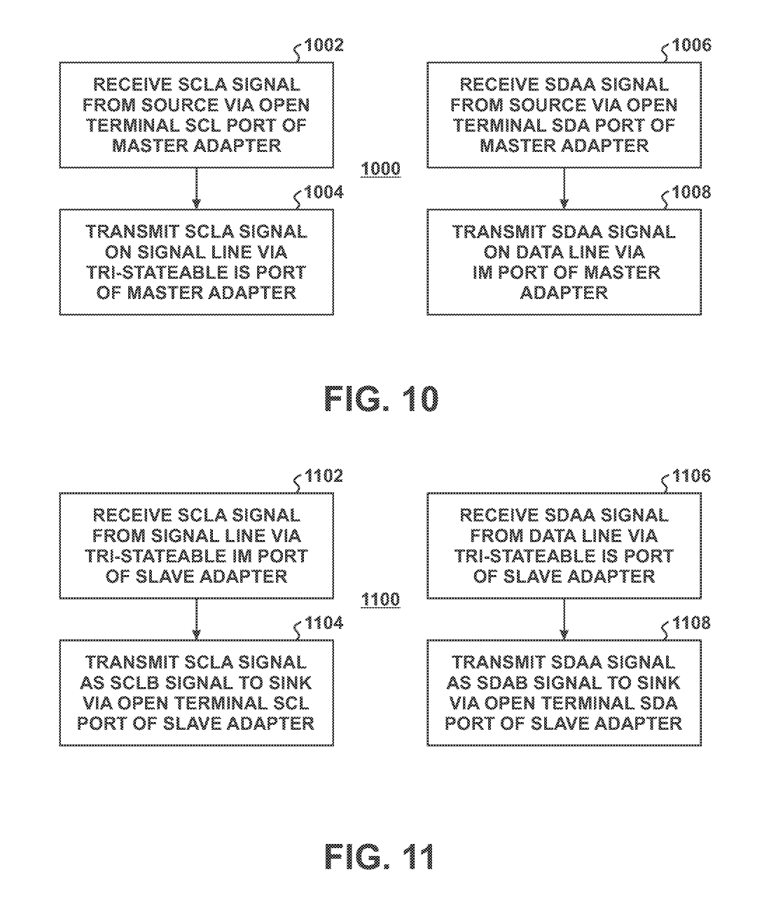

At block 412, the bus adapter device 300 enters a transmission mode whereby the bus adapter device 300 is configured to operate as a master-type bus adapter device, such as performing write operations and read operations as a master device based on the clock mode for which the bus adapter device 300 is configured. Example techniques for write operations and read operations are described herein with reference to FIGS. 10-20.

Alternately, in response to determining at block 404 that the bus adapter device 300 is a slave-type bus adapter device (for a particular data transaction or a series of data transactions), the bus adapter device 300 configures itself as a slave-type bus adapter device at block 414. Example slave-type bus adapter device configurations and operations are described in detail herein.

At block 416, the bus adapter device 300, as a slave-type device, receives the clock mode indicator transmitted by a master-type bus adapter device (at block 410) and configures itself based on the indicated clock mode. At block 418, the bus adapter device 300 enters a transmission mode whereby the bus adapter device 300 can perform write operations and read operations as a slave device based on the clock mode for which the bus adapter device 300 is configured.

Referring to FIG. 5, an example method 500 for determining whether the bus adapter device 300 is a master-type bus adapter device or a slave-type bus adapter device is illustrated in accordance with at least one embodiment of the present disclosure. The method 500 illustrates one embodiment of the process performed at block 404 of method 400 (FIG. 4).

In response to an initialization stimulus, each bus adapter device 300 of the bus interconnect (e.g., two-wire bus interconnect 104, FIG. 1) drives its tristateable push-pull port 310 high (e.g., Vdd) at block 502, and tristates its push-pull port 312. In an I2C-type bus, the SDA line is pulled high (e.g., Vdd) by a resistor (i.e., active low) and the master device initially controls the SDA line and thus it is the master device that initially drives the SDA line low (e.g., Vss or GND). Accordingly, at block 504, each bus adapter device 300 monitors its open-terminal port 306, its open-terminal port 308, or a combination thereof, to determine whether a data transaction is being initiated via the I2C bus segment connected to the bus adapter device 300. In one embodiment, the initiation of a data transaction at the I2C bus segment is indicated by a start condition, and thus the bus adapter device 300 can monitor its open-terminal ports 306 and 308 to detect whether a start condition (e.g., a transition event whereby the SCL line transitions from one state (e.g., logic high) to another state (e.g., logic low) while the while the SDA line is in a particular state (e.g., logic low)), which would indicate the open-terminal port 306 of the bus adapter device 300 is connected to the SDA line of the master device and thus the bus adapter device 300 is the master-type bus adapter device. In an alternate embodiment, rather than trying to detect an I2C-type start condition, each bus adapter device 300 monitors the open-terminal port 306 to determine whether there a specified transition event (e.g., a falling edge) has occurred on the SDA line without reference to a particular state of the SCL line.

In the event that the bus adapter device 300 determines, via its open-terminal port 306, that a data transaction is being initiated at the I2C bus segment and thus the bus adapter device 300 is associated with the master, or source, device, at block 506 the bus adapter device 300 identifies itself as the master-type bus adapter device and identifies the line of the intermediate bus segment connected to the tristateable push-pull port 312 as the signal line 128 and the line of the intermediate bus segment connected to the tristateable push-pull port 310 as the data line 126. Accordingly, at block 506 the bus adapter device 300 drives the data line 126 to a low logic level for a predetermined duration via its tristateable push-pull port 310 and drives the signal line 128 to a high logic level via its tristateable push-pull port 312. As discussed below, by driving the data line 126 low for the predetermined duration, the master-type bus adapter device signals to the other bus adapter device that it is the master and thus the other bus adapter device is a slave-type bus adapter device. The process then continues to block 406 of the method 400 of FIG. 4.

In the event that the bus adapter device 300 does not detect that the initiation of a data transaction at its associated I2C segment at block 504, at block 508 the bus adapter device 300 determines whether a data transaction has been initiated over the intermediate bus segment connected to its tristateable push-pull port 312 by another bus adapter device. In one embodiment, the bus adapter device 300 determines that a data transaction is being initiated on the intermediate bus segment by determining, via one of its push-pull ports, that the data line 126 has been driven to a low logic value for at least the predetermined duration discussed above. If not, the bus adapter device 300 enters an idle state and the process of blocks 504 and 508 repeats until the initiation of a data transaction is detected.

As noted above, the master-type bus adapter device drives its tristateable push-pull port 310 low in response to determining that it is the master-type bus adapter device. Thus, in the cross-coupled configuration of FIG. 2 whereby the tristateable push-pull-port 310 of one bus adapter device 300 is coupled to the tristateable push-pull port 312 of another bus adapter device 300, if a bus adapter device 300 detects the line connected to its tristateable push-pull port 312 is being driven low, the bus adapter device 300 identifies itself as a slave-type bus adapter device and therefore identifies its tristateable push-pull port 312 as connected to the data line 126 and identifies its tristateable push-pull port 310 as connected to the signal line 128 at block 510. Further at block 510, the bus adapter device 300 tristates its tristateable push-pull port 310 in preparation for the transmission of data and other non-clock information via the data line 126 by the master-type bus adapter device. The process then continues to block 414 of method 400 of FIG. 4.

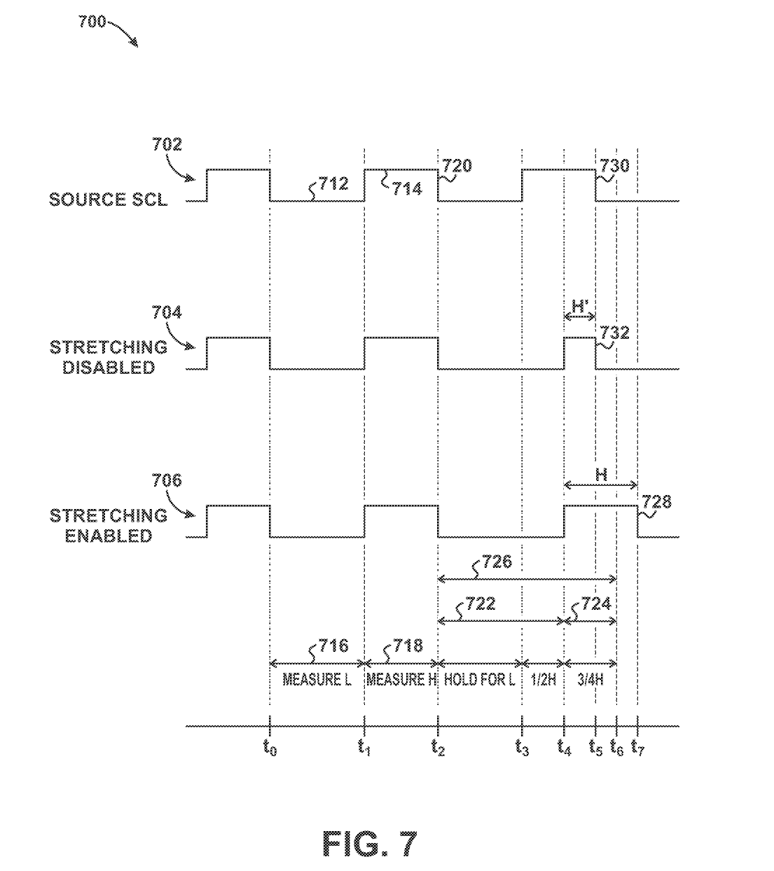

Referring to FIGS. 6 and 7, an example method 600 (FIG. 6) and an example timing diagram 700 (FIG. 7) for determining a clock mode of a master device are illustrated in accordance with at least one embodiment of the present disclosure. The method 600 illustrates one embodiment of the process performed at block 408 of method 400 (FIG. 4).

In the timing diagram 700, the source SCL signal 702 represents a clock signal that would be provided by the master device (e.g., source device 102, FIG. 1) without modification due to attempts at clock-stretching, the stretching-disabled SCL signal 704 is representative of a SCL signal whereby the master device does not facilitate clock stretching, and the stretching-enabled SCL signal 706 is representative of a SCL signal whereby the master device facilitates clock stretching.

The bus adapter device 300 associated with the master device receives a SCL signal initially similar to the source SCL signal 702, whereby the clock cycles of the SCL signal from the master device initially have a first phase (e.g., a low state) and a second phase (e.g., a high state) equal to the first phase 712 and the second phase 714, respectively, of the source SCL signal 702. At block 602 of the method 600, the adapter control module 302 of the bus adapter device 300 determines the duration L (duration 716, FIG. 7) of the first phase of a clock cycle of the received SCL signal (e.g., between the falling edge at time t0 and the rising edge at time t1) and at block 604, the adapter control module 302 determines the duration H (duration 718, FIG. 7) of the second phase of the clock cycle (alternately, the second phase of a subsequent clock cycle)(e.g., between the rising edge at time t1 and the falling edge at time t2). The duration L and the duration H can be measured by the adapter control module 302 by, for example, counting the clock cycles of the clock signal 314 (FIG. 3) between edge transitions of the received SCL signal.

At the end of the second phase a clock cycle of the received SCL signal (e.g., in response to the edge transition 720 at time t2 marking the end of the second phase), the adapter control module 302 configures, via the control signal 326, the pull-down transistor 326 to drive the SCL line low for a duration X (duration 722) between time t2 and time t4, (whereby X=L+A*H, 0<A<1), thereby simulating a clock-stretching operation that would be performed by a slave device. At block 608, the adapter control module 302 configures, via the control signal 326, the pull-down transistor 326 to release the SCL line at the end of duration X at time t4, which allows the resistive element 330 (FIG. 3) to pull the SCL line high. Further at block 608, the adapter control module 302 waits a duration Y (duration 724) after releasing the SCL line at time t4 (where Y=B*H, 0<B<1, A+B>1).

A master device that enables clock stretching in accordance with the I2C standard ensures that each phase of the SCL clock signal is fully implemented once clock stretching by a slave device is terminated. Thus, as illustrated by the stretching enabled SCL signal 706, a clock-stretching enabled master device would drive the SCL line high for the full duration H of the second phase of a clock cycle between time t4 and time t7 in response to the SCL line being released by the bus adapter device 300 at time t4. Conversely, a master device that does not enable clock stretching continues to attempt to maintain the periodic clock signaling represented by the source SCL signal 702, and thus drives the SCL line high for only a partial duration H′ between time t4 and t5. Thus, in a clock-stretching enabled configuration, the edge transition 728 at the end of the first clock cycle phase to follow the release of clock stretching would occur after the edge transition 730 of the source SCL signal 702, whereas, in a clock-stretching disabled configuration, the edge transition 732 at the end of the first clock cycle phase to follow the release of clock stretching would occur at the same time at the edge transition 730.

Accordingly, further at block 608, the adapter control module 302 samples the received SCL signal at time t6 at the end of duration Y (i.e., at the end of duration 726 from time t2) to determine the state of the received SCL signal at time t6. In one embodiment, the process of blocks 606 and 608 can be repeated for a number of times in succession to generate a plurality of sampled states of the received SCL signal so as to reduce an incorrect mode detection due to glitches or other perturbations. At block 610, the adapter control module 302 determines whether the sampled value or sampled values of the received SCL signal are equal to the value expected if clock stretching is enabled. To illustrate using the timing diagram of FIG. 7, if the master device does not enable clock stretching and thus the received SCL signal is represented by the stretching-disabled SCL signal 704, the value sampled at time t6 would be a low value, thereby indicating that the master device does not enable clock stretching. If the master device does enable clock stretching and thus the received SCL signal is represented by the stretching-enabled signal 706, the value sampled at time t6 would be a high value, thereby indicating that the master device does enable clock stretching. This process may be repeated one or more times in order to provide an added degree of error tolerance.

If the sampled value is equivalent to the expected clock-stretching enabled value, at block 614 the bus adapter device 300 identifies the clock mode of the master device as facilitating clock stretching at block 614 and configures itself to operate in a clock stretching-disabled mode as described herein. Otherwise, the bus adapter device 300 identifies the master device as failing to facilitate clock stretching at block 616 and configures itself to operate in a clock stretching-disabled mode as described herein. In implementations whereby the process is repeated multiple times to generate multiple sampled states of the SCL line, the majority of the comparison results can be used to determine the clock mode of the master device to improve error tolerance. A clock mode indicator indicating the identified clock mode then can be transmitted to the other bus adapter device as described herein.

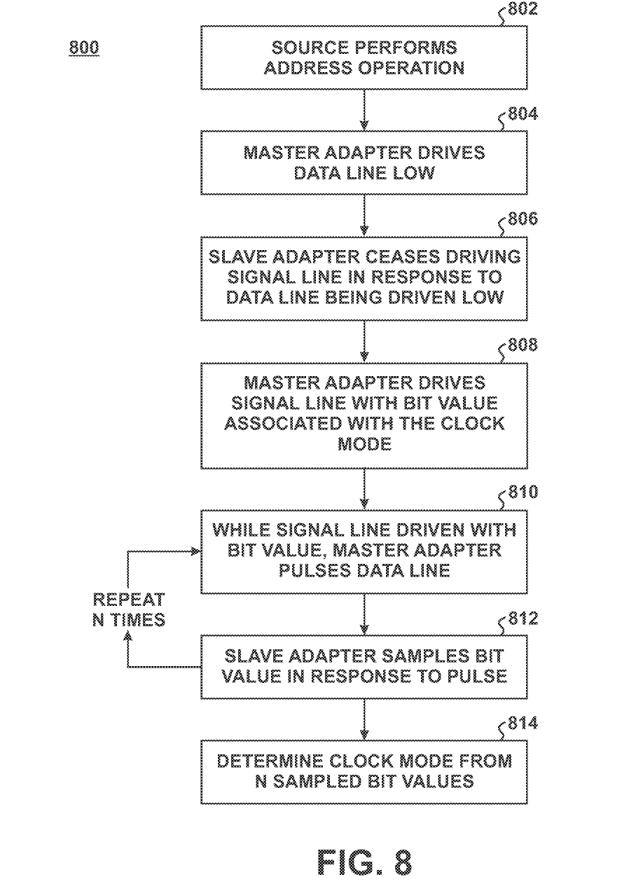

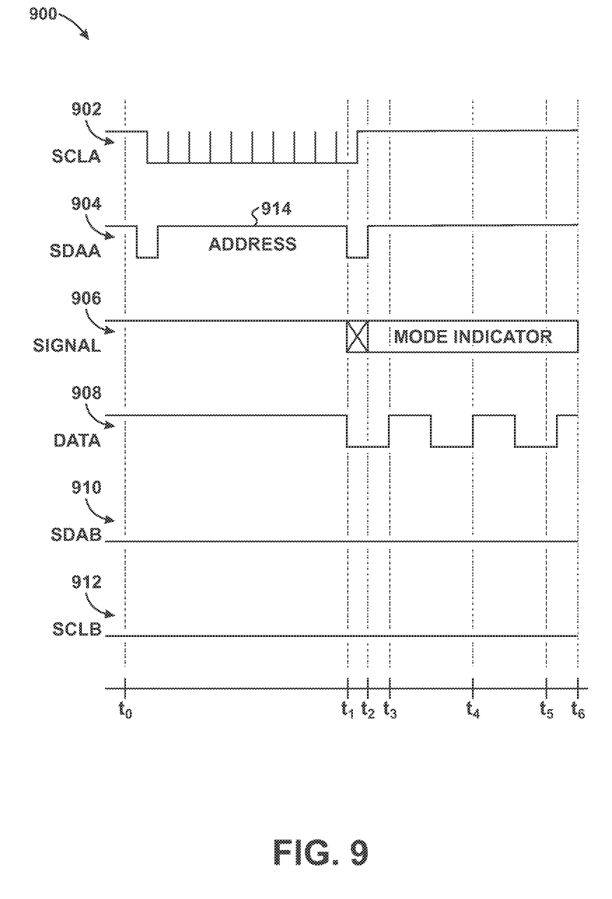

Referring to FIGS. 8 and 9, an example method 800 (FIG. 8) and timing diagram 900 (FIG. 9) illustrating the communication of a clock mode indicator from a master-type bus adapter device to a slave-type bus adapter device is illustrated in accordance with at least one embodiment of the present disclosure. The method 800 illustrates one embodiment of the process performed at block 410 of the method 400 (FIG. 4).

In the example of FIGS. 8 and 9, the bus adapter device 114 (FIG. 1) is assumed to be the master-type bus adapter device and the bus adapter device 116 (FIG. 1) is assumed to be the slave-type bus adapter device. In the timing diagram 900 of FIG. 9, the SCLA signal 902 represents the signaling at the SCL line 120, the SDAA signal 904 represents the signaling at the SDA line 118, the signal 906 represents the signaling at the signal line 128, the data signal 908 represents the signaling at the data line 126, the SDAB signal 910 represents the signaling at the SDA line 122 and the SCLB signal 912 represents the signaling at the SCL line 124.

At block 802, the source device 102 initiates a transaction by driving the SDA line 118 low at t0 (thereby indicating a start condition) and then transmits address information 914 (e.g., address data bits, a read/write bit) in the SDAA signal 904 while cycling the SCLA signal 902 on the SCL line 120 accordingly. At the end of the address transmission, the source device 102 pulses the SDAA signal 904 at time t1 while the SCLA signal 902 is high, thereby indicating the termination of the address operation. In response to the termination of the address operation, the bus adapter device 114 drives the data line 126 low at time t1. In response to the data line 126 being driven low, the bus adapter device 116 identifies itself as the slave and ceases driving the signal line at block 806.

At block 808, the bus adapter device 114 drives the signal line 128 with a clock mode indicator value (e.g., clock stretching enabled=high; clock stretching disabled=low) representing the clock mode identified at block 408 of method 400 (FIG. 2). While the signal line 128 is being driven with the clock mode indicator value, at block 810 the bus adapter device 114 pulses the data line 126 at time t3. In response to the pulse on the data line 126, the bus adapter device 116 samples the signal line 128 to determine the clock mode indicator value at block 814.

In one embodiment, the bus adapter device 116 then uses the sampled value to set the clock mode at the bus adapter device 116 at block 814. However, in certain instances, a glitch may occur that causes a corrupted value to be sampled. Accordingly, to improve error recovery capabilities, the bus adapter device 114 maintains the clock mode indicator value on the signal line 128 from time t2 to time t6, during which time the data line 126 is pulsed N times (e.g., at times t3, t4, and t5), and the bus adapter device 116 samples the clock mode indicator value from the signal line 128 in response to each of the N pulses, thereby generating N sampled clock mode indicator values. The bus adapter device 116 then can more accurately identify the correct clock mode indicator value at block 814 by, for example, using the majority of the N sampled clock mode indicator values as the correct clock mode indicator value. This multiple redundancy therefore allows the clock mode communication process to be more tolerant of glitches that may occur.

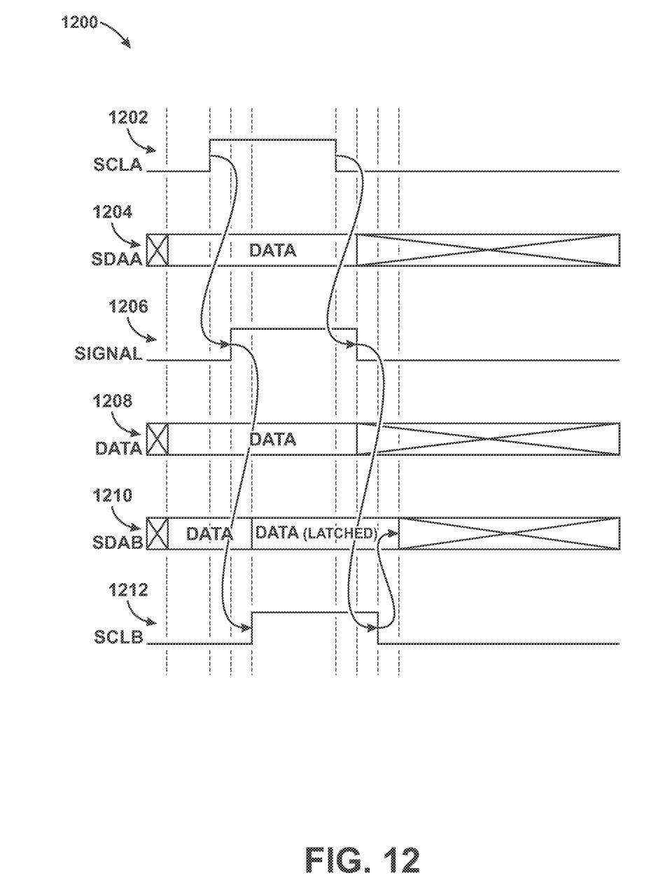

Referring to FIGS. 10-12, an example write operation for transmitting a bit from a master device to a slave device via a bus interconnect utilizing the bus adapter devices 300 in a clock stretching disabled mode is illustrated in accordance with at least one embodiment of the present disclosure. In the timing diagram 1200 of FIG. 12, the SCLA signal 1202 represents the signaling at the SCL line 120, the SDAA signal 1204 represents the signaling at the SDA line 118, the signal 1206 represents the signaling at the signal line 128, the data signal 1208 represents the signaling at the data line 126, the SDAB signal 1210 represents the signaling at the SDA line 122 and the SCLB signal 1212 represents the signaling at the SCL line 124. In FIG. 12 and subsequent Figures, signals driven by a slave-type adapter device or a slave device are illustrated using dashed lines.

For ease of illustration, the write operation process is described in the bus interconnect context of FIGS. 2 and 3 and it is assumed that the bus adapter device 114 is the master-type bus adapter device and the bus adapter device 116 is the slave-type bus adapter device.

FIG. 10 illustrates a method 1000 representing the operation of the bus adapter device 114 for the transmission of a bit during a write operation on the bus interconnect. As illustrated by method 1000, in a clock stretching disabled mode the bus adapter device 114 is configured to communicate (i.e., transmit, receive, or a combination thereof) data information between the open-terminal port 132 and the push-pull port 138 and transmit clock information from the open-terminal port 132 to the push-pull port 140. Accordingly, at block 1002, the bus adapter device 114 receives the SCLA signal 1202 from the source device 102 via the open-terminal port 134 (open-terminal port 308, FIG. 3). At block 1004, the bus adapter device 114 buffers and transmits the clock information represented by the SCLA signal 1202 as the signal 1206 via the tristateable push-pull port 140 (tristateable push-pull port 312, FIG. 3) as the IS port of the bus adapter device 114. The delay between the SCLA signal 1202 and the signal 1206 in the timing diagram 1200 represents the buffering delay of the tristate buffer 352.

At block 1006, the bus adapter device 114 receives the SDAA signal 1204 representing the bit to be transmitted from the source device 102 via the open-terminal port 136 (open-terminal port 306, FIG. 3). At block 1008, the bus adapter device 114 buffers and transmits the data information represented by the SDAA signal 1204 as the data signal 1208 via the tristateable push-pull port 138 (tristateable push-pull port 310, FIG. 3) as the IM port of the bus adapter device 114. The delay between the SDAA signal 1204 and the data signal 1208 in the timing diagram 1200 represents the buffering delay of the tristate buffer 342.

FIG. 11 illustrates a method 1100 representing the operation of the bus adapter device 116 for the reception of a bit during a write operation on the bus interconnect. As illustrated by method 1100, in a clock stretching disabled mode the bus adapter device 116 is configured to communicate (i.e., transmit, receive, or a combination thereof) data information between the open-terminal port 152 and the push-pull port 160 and transmit clock information from the push-pull port 158 to the open-terminal port 154. Accordingly, at block 1102, the bus adapter device 116 receives the clock information represented by the signal 1206 via the push-pull port 158 (push-pull port 310, FIG. 3). At block 1104, the bus adapter device 116 buffers and transmits the clock information represented by the signal 1206 as the SCLB signal 1212 via the open-terminal port 154 (open-terminal port 308, FIG. 3) as the SCL port of the bus adapter device 116. The delay between the signal 1206 and the SCLB signal 1212 in the timing diagram 1200 represents the buffering delay of the tristate buffer 342.

At block 1104, the bus adapter device 116 receives the data information represented by the data signal 1208 via the push-pull port 160 (push-pull port 312, FIG. 3). At block 1104, the bus adapter device 116 buffers and transmits the data information represented by the data signal 1208 as the SDAB signal 1210 via the open-terminal port 152 (open-terminal port 306, FIG. 3) as the SDA port of the bus adapter device 116. The delay between the data signal 1208 and the SDAB signal 1210 in the timing diagram 1200 represents the buffering delay of the tristate buffer 352.

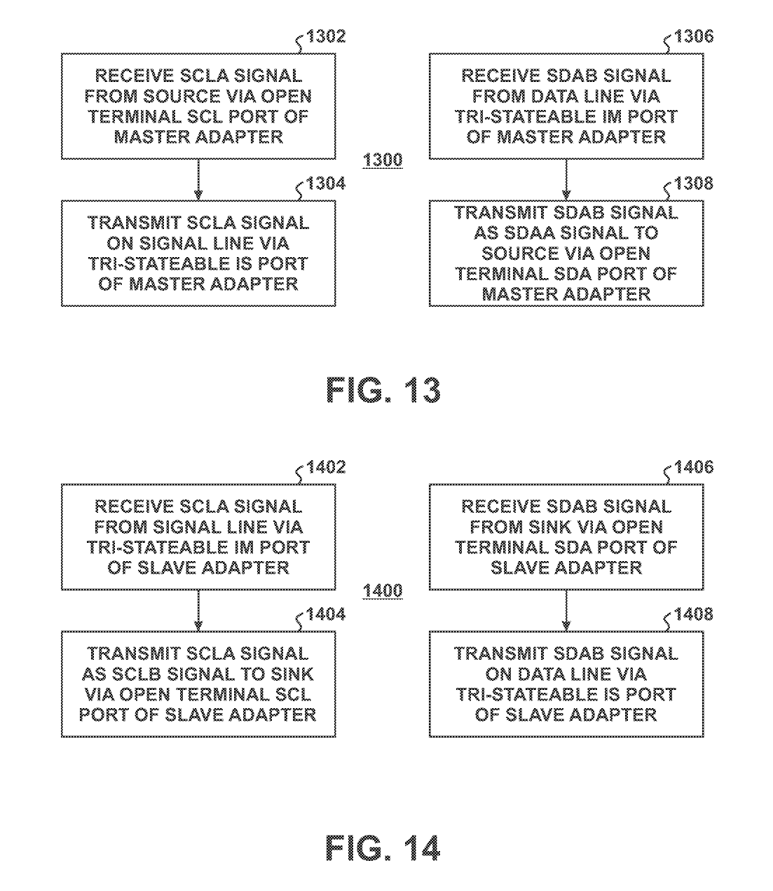

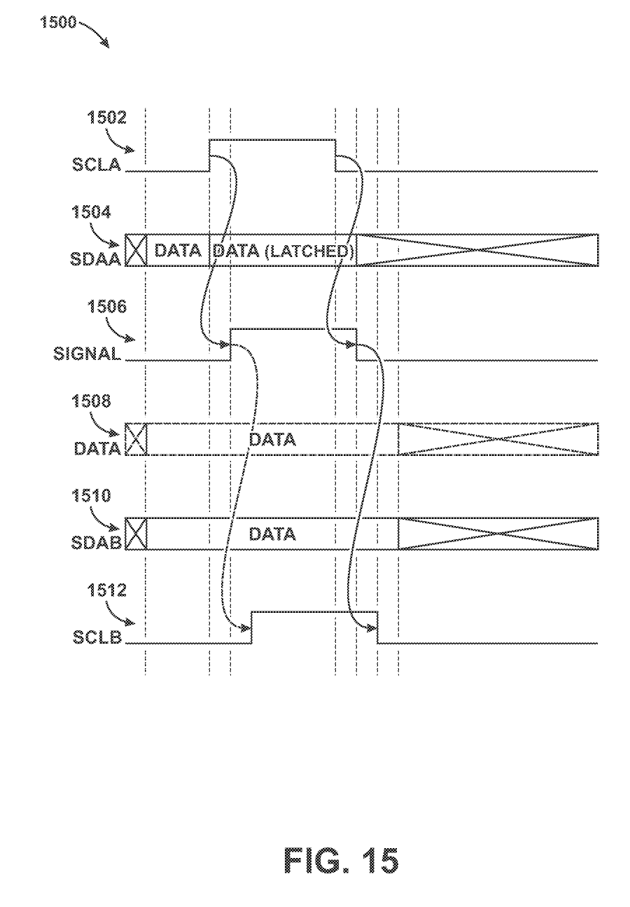

Referring to FIGS. 13-15, an example read operation for transmitting a bit from a slave device to a master device via a bus interconnect utilizing the bus adapter devices 300 in a clock stretching disabled mode is illustrated in accordance with at least one embodiment of the present disclosure. In the timing diagram 1500 of FIG. 15, the SCLA signal 1502 represents the signaling at the SCL line 120, the SDAA signal 1504 represents the signaling at the SDA line 118, the signal 1506 represents the signaling at the signal line 128, the data signal 1508 represents the signaling at the data line 126, the SDAB signal 1510 represents the signaling at the SDA line 122, and the SCLB signal 1512 represents the signaling at the SCL line 124. For ease of illustration, the read operation process is described in the bus interconnect context of FIGS. 2 and 3 and it is assumed that the bus adapter device 114 is the master-type bus adapter device and the bus adapter device 116 is the slave-type bus adapter device. Further, in the timing diagram 1500, signaling represented by a dashed line represents signaling initiated by the bus adapter device 116 (as a slave-type bus adapter device).

FIG. 13 illustrates a method 1300 representing the operation of the bus adapter device 114 for the transmission of a bit from the bus adapter device 116 to the bus adapter device 114 during a read operation on the bus interconnect. As described above, in a clock stretching disabled mode the bus adapter device 114 is configured to communicate (i.e., transmit, receive, or a combination thereof) data information between the open-terminal port 132 and the push-pull port 138 and transmit clock information from the open-terminal port 132 to the push-pull port 140. Accordingly, at block 1302, the bus adapter device 114 receives the SCLA signal 1502 from the source device 102 via the open-terminal port 134 (open-terminal port 308, FIG. 3). At block 1304, the bus adapter device 114 buffers and transmits the clock information represented by the SCLA signal 1502 as the signal 1506 via the tristateable push-pull port 140 (tristateable push-pull port 312, FIG. 3) as the IS port of the bus adapter device 114. The delay between the SCLA signal 1202 and the signal 1206 in the timing diagram 1200 represents the buffering delay of the tristate buffer 352.

At block 1306, the bus adapter device 114 receives the data signal 1506 via the push-pull port 138 (push-pull port 310, FIG. 3). The data signal 1506, in this embodiment, is a representation of the SDAB signal 150 that represents the bit transmitted from the sink device 104. At block 1308, the bus adapter device 114 buffers and transmits the data information represented by the data signal 1508 as the SDAA signal 1504 via the open-terminal port 132 (open-terminal port 306, FIG. 3).

FIG. 14 illustrates a method 1400 representing the operation of the bus adapter device 116 for the transmission of a bit during a read operation on the bus interconnect. As described above, in a clock stretching disabled mode the bus adapter device 116 is configured to communicate (i.e., transmit, receive, or a combination thereof) data information between the open-terminal port 152 and the push-pull port 160 and transmit clock information from the push-pull port 158 to the open-terminal port 154. Accordingly, at block 1402, the bus adapter device 116 receives the clock information represented by the signal 1506 via the push-pull port 158 (push-pull port 310, FIG. 3). At block 1104, the bus adapter device 116 buffers and transmits the clock information represented by the signal 1506 as the SCLB signal 1512 via the open-terminal port 154 (open-terminal port 308, FIG. 3). The delay between the signal 1506 and the SCLB signal 1512 in the timing diagram 1500 represents the buffering delay of the tristate buffer 342.

At block 1406, the bus adapter device 116 receives the SDAB signal 1510 representative of the read bit data via the open-terminal port 122 (open-terminal port 308, FIG. 3). At block 1408, the bus adapter device 116 buffers and transmits the read bit data represented by the SDAB signal 1510 as the data signal 1508 via the push-pull port 160 (push-pull port 312, FIG. 3).

As FIGS. 10-15 illustrate, the bus adapter devices 114 and 116 can operate as pass-through bus adapter devices when clock stretching is disabled. As such, each of the bus adapter devices 114 and 116 can operate to convert received open-terminal based signaling to the corresponding push-pull based signaling, and vice versa, thereby reducing or eliminating signal degradation effects across the push-pull-based bus segment that otherwise would be present in an open-terminal-based segment. Each data transaction can utilize both read and write bit operations in a specific sequence determined by the particular operation being performed. In the course of a single transaction, such as reading one byte from the sink device 106, the actual operation switches between the operation represented in FIG. 13 and the operation represented in FIG. 14 as appropriate.

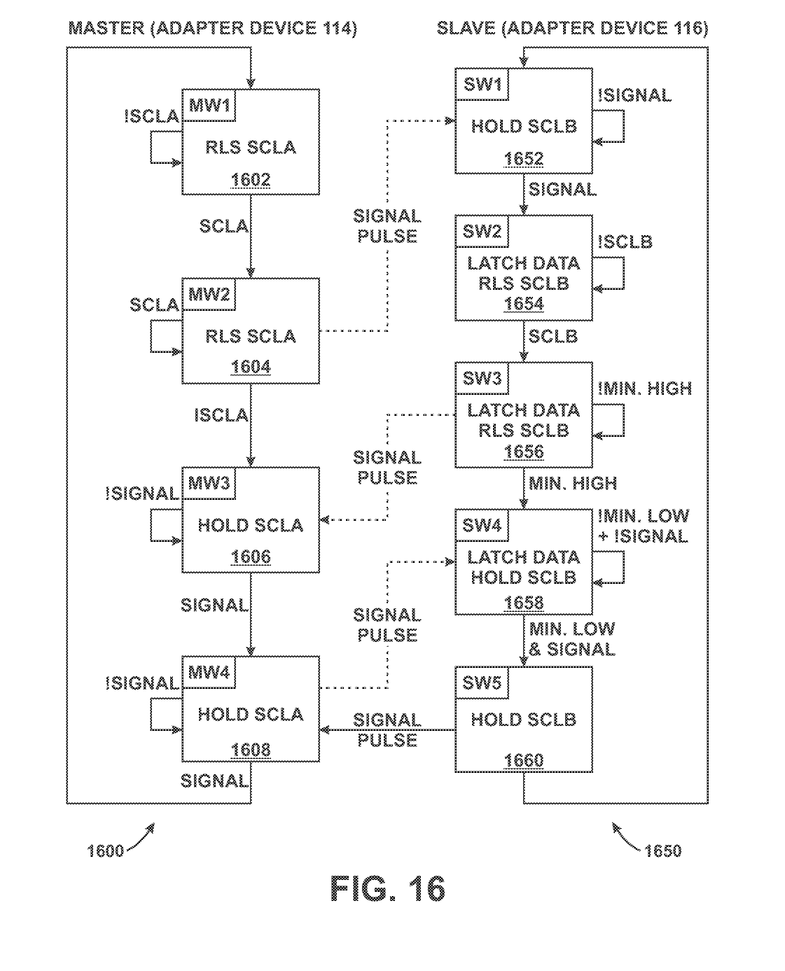

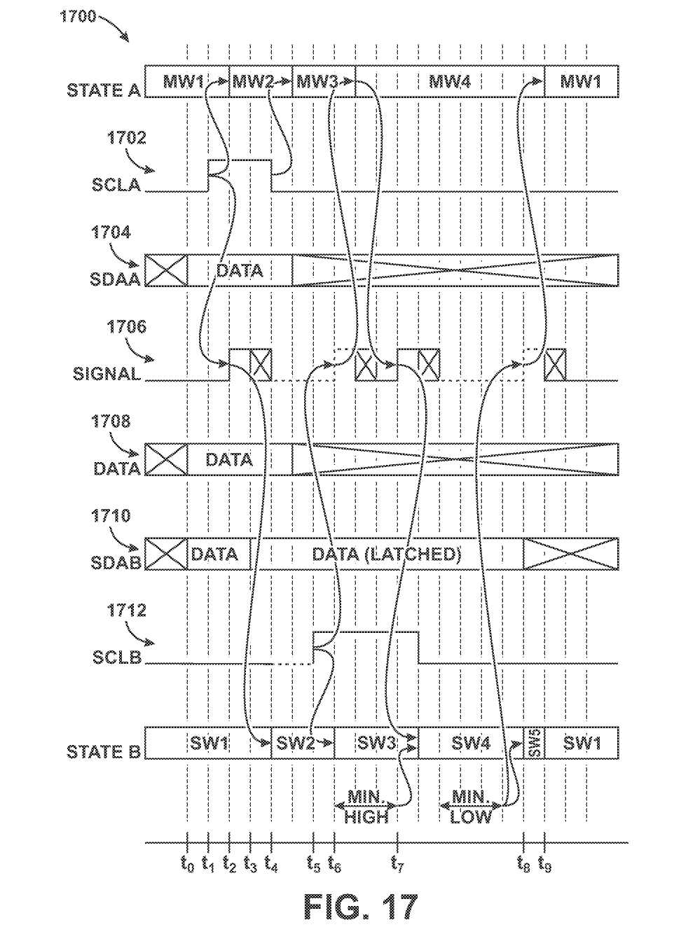

Referring to FIGS. 16 and 17, an example write operation for transmitting a bit from a master device to a slave device via a bus interconnect utilizing the bus adapter devices 300 whereby clock stretching is enabled is illustrated in accordance with at least one embodiment of the present disclosure. In the timing diagram 1700 of FIG. 17, the SCLA signal 1702 represents the signaling at the SCL line 120, the SDAA signal 1704 represents the signaling at the SDA line 118, the signal 1706 represents the signaling at the signal line 128, the data signal 1708 represents the signaling at the data line 126, the SDAB signal 1710 represents the signaling at the SDA line 122 and the SCLB signal 1712 represents the signaling at the SCL line 124. For ease of illustration, the one-bit write operation process is described in the bus interconnect context of FIGS. 1-3 and it is assumed that the bus adapter device 114 is the master-type bus adapter device and the bus adapter device 116 is the slave-type bus adapter device. Further, in the timing diagram 1700, signaling represented by a dashed line represents signaling initiated by the bus adapter device 116 (as a slave-type bus adapter device).

FIG. 16 illustrates a state machine diagram 1600 representing a state machine implemented by the adapter control module 302 (FIG. 3) of the bus adapter device 114 and a state machine diagram 1650 representing a state machine implemented by the adapter control module 302 of the bus adapter device 116. As illustrated by the state machine diagram 1600 and the corresponding timing diagram 1700, in a clock stretching enabled mode the bus adapter device 114 is configured to communicate data information between the open-terminal port 132 and the push-pull port 138, communicate clock information via the open-terminal port 134, and communicate handshake information via the push-pull port 140, whereby the handshake information is responsive to the clock information and vice versa. Likewise, in a clock stretching enabled mode the bus adapter device 116 is configured to communicate data information between the open-terminal port 152 and the push-pull port 160, communicate clock information via the open-terminal port 154, and communicate handshake information via the push-pull port 158, whereby the handshake information is responsive to the clock information and vice versa.

The term “handshake information,” as used herein, refers to the communication of handshake indicators via an intermediate two-wire bus interconnect. While handshake information is based on clock information (e.g., a received SCL signal), it is not solely based on clock information, but instead is also based on other states of the system in which it is implemented, as described herein. Thus, handshake information is not merely a reproduction of a clock signal, such as the transmission of a buffered clock signal or an inverted clock signal. Likewise, while the communication of clock information can be based on handshake information as described herein, clock information is not merely a reproduction of handshake information, such as the retransmission of received handshake indicators, etc.

The state machine diagram 1600 of the bus adapter device 114 includes states 1602, 1604, 1606, and 1608 (also referred to herein as states MW1-MW4, respectively). The state machine diagram 1650 of the bus adapter device 116 includes states 1652, 1654, 1656, 1658 and 1660 (also referred to herein as states SW1-SW5). Initially at state 1602, the bus adapter device 114 is not driving the SCL line 120 (SCLA) and the source device 102 is driving the SCL line 120 low. Initially at state 1652, the bus adapter device 116 is driving the SCL line 124 (SCLB) low and passing the unknown data value at the data line 126 to the sink device 106 via the SDA line 122 (SDAB). At time t0, the source device 102 drives a bit value onto the SDA line 118 (SDAA) and at time t1, the source device 102 releases the SCL line 120 (SCLA) so that it goes high. The bus adapter device 114 drives the received bit value of the SDA line 118 onto the data line 126.

In response to the SCL line 120 going high, the bus adapter device 114 enters state 1604, whereby the bus adapter device 114 transmits a handshake indicator via the signal line 128. In the illustrated example, handshake indicators are represented by signal pulses on the signal line 128. In order to generate the signal pulse representing the handshake indicator at time t2, the bus adapter drives the signal line 128 at time t2 for a duration sufficient to be detected by the bus adapter device 116 and then tristates its push-pull port 140 (as represented by the “X” boxes in signal 1706) at time t3 so that it can act as a receiver with respect to the signal line 128. For ease of discussion, the driving of the signal line 128 high for a duration sufficient to be detected by the other bus adapter device is referred to herein as “pulsing” the signal line 128 and the resulting effect is referred to herein as a “signal pulse” on the signal line 128. Although handshake indicators are illustrated herein as signal pulses, other handshake indicators, such as edge transitions on the signal line 128, may be used without departing from the scope of the present disclosure.

In response to detecting the handshake indicator (e.g., signal pulse) on the signal line 128 at time t2, the bus adapter device 116 enters state 1654 whereby the bit value on the data line 126 is latched by the bus adapter device 116 and driven onto the SDA line 122 for receipt by the sink device. The sink device 106 can stretch the clock signal so as to process the received bit by driving the SCL line 124 (SCLB) low until processing is substantially complete at time t5. Accordingly, at time t4 the sink device 106 releases the SCL line 124, thereby causing the SCL line 124 to be pulled high. In response to the SCL line 124 being pulled high, the bus adapter device 114 enters state 1656, whereby the bus adapter device 116 transmits a second handshake indicator by pulsing the signal line 128 at time t6 and then the bus adapter device 116 tristates its push-pull port 160 so as to configure the bus adapter device 116 as a receiver with respect to the signal line 128. Further, in state 1656 the bus adapter device 116 continues to drive the latched bit value from the data line 126 onto the SDA line 122 (SDAB).

At some point (time t4 in the timing diagram 1700), the source device 102 drives the SCL line 120 (SCLA) low, thereby causing the bus adapter device 114 to enter state 1606 whereby the bus adapter device 114 holds the SCL line 120 low. In response to detecting the second handshake indicator on the signal line 128 at time t6, the bus adapter device 114 enters state 1608, whereby the bus adapter device 114 transmits a third handshake indicator by pulsing the signal line 128 at time t7 and then the bus adapter device 114 tristates its push-pull port 140 so as to act as a receiver. Further, the bus adapter device 114 continues to hold the SCL line 120 low, thereby stretching the clock at the source device 102.

When entering state 1656 at time t6, the bus adapter device 116 initiates a timer that waits for the minimum SCL high time (MinHigh) specified by the I2C standard or other applicable standard. When both the MinHigh timer has lapsed in state 1656 and the bus adapter device 116 has detected the third handshake indicator (e.g., the signal pulse on the signal line 128 at time t7), the bus adapter device 116 drives the SCL line 124 (SCLB) low and enters state 1658. In state 1658, the bus adapter device 116 initiates a time that waits for the minimum SCL low time (MinLow) specified by the I2C standard or other applicable standard. When the MinLow timer lapses in state 1658, the bus adapter device 116 enters state 1660, whereby the bus adapter device 116 transmits a fourth handshake indicator by pulsing the signal line 128 at time t8, tristates its push-pull port 160, and then returns to state 1652 at time t9. When the bus adapter device 114 detects the pulse on the signal line 128 at time t8 while in state 1608, the bus adapter device 114 returns to state 1602. The technique of waiting for both the expiration of MinHigh and MinLow aids in ensuring that the SCLB signal 1712 meets the critical timing specifications of the I2C standard even when the SCLA signal 1702 is operating under a faster specification. Further, waiting for both the expiration of MinHigh and MinLow prevents the transmission of data by the source device from getting ahead of the reception of the data by the sink device.

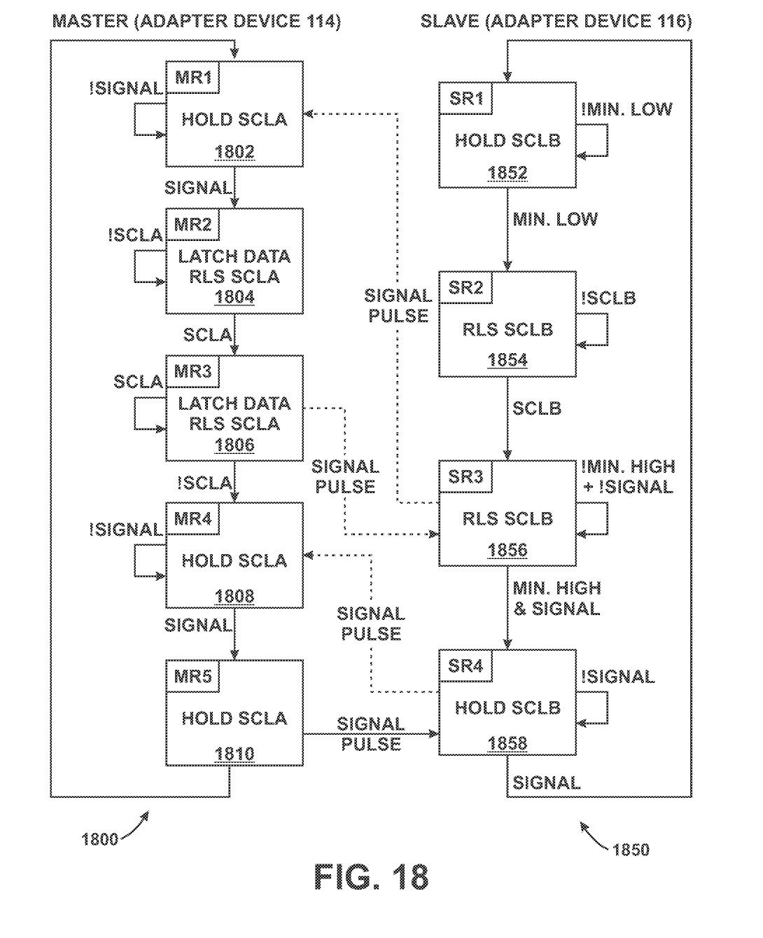

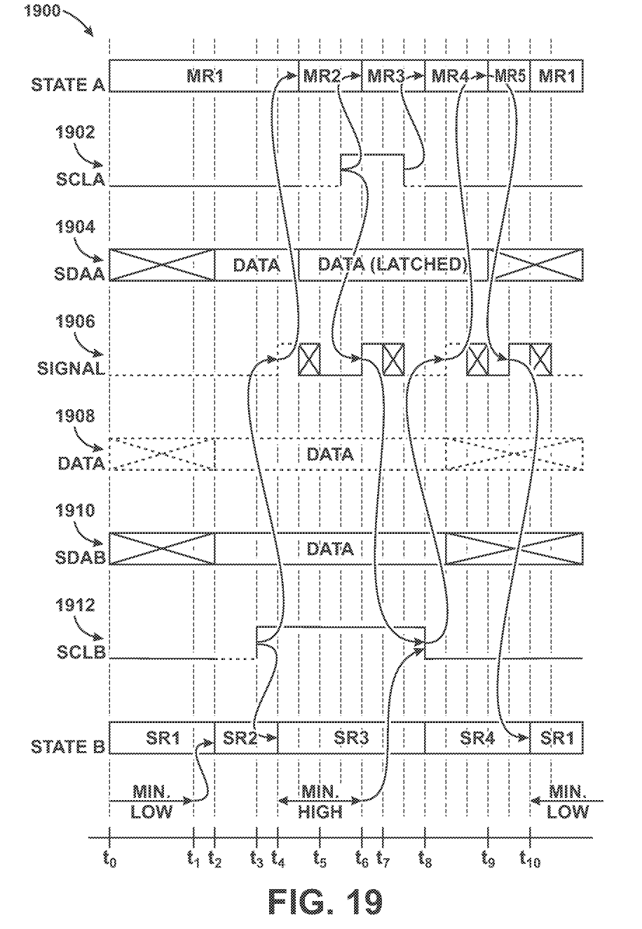

Referring to FIGS. 18 and 19, an example read operation for transmitting a bit from a slave device to a master device via a bus interconnect utilizing the bus adapter devices 300 whereby clock stretching is enabled is illustrated in accordance with at least one embodiment of the present disclosure. In the timing diagram 1900 of FIG. 19, the SCLA signal 1902 represents the signaling at the SCL line 120, the SDAA signal 1904 represents the signaling at the SDA line 118, the signal 1906 represents the signaling at the signal line 128, the data signal 1908 represents the signaling at the data line 126, the SDAB signal 1910 represents the signaling at the SDA line 122 and the SCLB signal 1912 represents the signaling at the SCL line 124. For ease of illustration, the one-bit read operation process is described in the bus interconnect context of FIGS. 1-3 and it is assumed that the bus adapter device 114 is the master-type bus adapter device and the bus adapter device 116 is the slave-type bus adapter device. Further, in the timing diagram 1900, signaling represented by a dashed line represents signaling initiated by the bus adapter device 116 (as a slave-type bus adapter device).

FIG. 18 illustrates a state machine diagram 1800 representing a state machine implemented by the adapter control module 302 (FIG. 3) of the bus adapter device 114 and a state machine diagram 1850 representing a state machine implemented by the adapter control module 302 of the bus adapter device 116. The state machine diagram 1800 of the bus adapter device 114 includes states 1802, 1804, 1806, 1808, and 1810 (also referred to herein as states MR1-MR5, respectively). The state machine diagram 1850 of the bus adapter device 116 includes states 1852, 1854, 1856, and 1858 (also referred to herein as states SR1-SR4). Initially at state 1802, the bus adapter device 114 holds the SCL line 120 (SCLA) low. Initially at state 1852, the bus adapter device 116 holds the SCL line 124 (SCLB) low. As it is a read operation, the sink device 106 is enabled to drive a bit value (initially unknown) onto the SDA line 122 (SDAB). For a read operation, the bus adapter device 114 is configured to drive the value at the data line 126 onto the SDA line 118 (SDAA) for receipt by the source device 102.

When entering state 1852, the bus adapter device 116 initiates a MinLow timer (described above) at time t0 to ensure that the SCL line 124 is driven low for a time sufficient to meet I2C specifications or other specifications. When the MinLow timer has lapsed at time t1, the bus adapter device 116 releases the SCL line 124 (SCLB) and enters state 1854. When the sink device 106 is ready to supply the read bit value, the sink device 106 drives the read bit value onto the SDA line 122 (SDAB) and releases the SCL line 124 (SCLB), thereby allowing the SCL line 124 to go high at time t3. The bus adapter device 116 drives the read bit value from the SDA line 122 (SDAB) onto the data line 126 via the push-pull port 160. In response to the SCL line 124 (SCLB) going high at time t3, the bus adapter device 116 enters state 1856, whereby the bus adapter device 116 transmits a first handshake indicator by puling the signal line 128 at time t4.

After detecting the first handshake indicator on the signal line 128 at time t4, the bus adapter device 114 enters state 1804, whereby the bus adapter device 114 releases the SCL line 120 (SCLA), latches the read bit value on the data line 126, and begins driving the latched read bit value onto the SDA line 118 (SDAA). When the source device 102 drives the SCL line 120 (SCLA) high at time t5, the actual bit transfer is initiated and the bit value on the SDA line 118 is latched at the source device 102 for processing at the source device 102. In response to the SCL line 120 (SCLA) being driven high, the bus adapter device 114 enters state 1806, whereby the bus adapter device 114 continues to latch the read data bit onto the SDA line 118 and transmits a second handshake indicator by pulsing the signal line 128 at time t6.

At some point (e.g., time t7 in the timing diagram 1900), the source device 102 pulls the SCL line 120 (SCLA) low, thereby causing the bus adapter device 114 to enter state 1808, during which the bus adapter device 114 holds the SCL line 120 low.

Upon entering state 1856, the bus adapter device 116 initiates the MinHigh timer (discussed above). Upon the lapse of the MinHigh timer and in response to detecting the second handshake indicator on the signal line 128 at time t6, the bus adapter device 116 enters state 1858. In state 1858, the bus adapter device 116 drives the SCL line 124 (SCLB) low and at time t8 transmits a third handshake indicator by pulsing the signal line 128. In response to detecting the third handshake indicator on the signal line 128, the bus adapter device 114 enters state 1810 whereby the bus adapter device 118 transmits a fourth handshake indicator by pulsing the signal line 128 at time t9 and then returns to state 1802 at time t10. In response to detecting the fourth handshake indicator on signal line 128, the bus adapter 116 enters state 1852, initiates the MinLow timer and continues to drive the SCL line 124 (SCLB) low.

As illustrated by FIGS. 16-19, the bus adapter devices 114 and 116 can utilize bidirectional handshake signaling in the form of the signal pulses or edge events on the signal line 128 to enable clock stretching at the master. To illustrate, at states 1606 and 1608 of state diagram 1600, the bus adapter device 114 holds the SCL line 120 low, thereby acting as a proxy for the sink device 106 with respect to clock stretching. The handshaking sequence of pulses on the signal line 128 that alternate between the bus adapter device 114 and the bus adapter device 116 are used, in effect, to provide a progress update for the processing of the data bit at the sink device 106. Thus, the fourth pulse provided by the bus adapter device 116 at time t8 serves as an indicator that the sink device 106 is substantially finished processing the data bit transmitted via the data line 126 and the bus adapter device 114 therefore can cease clock stretching by releasing the SCL line 120.

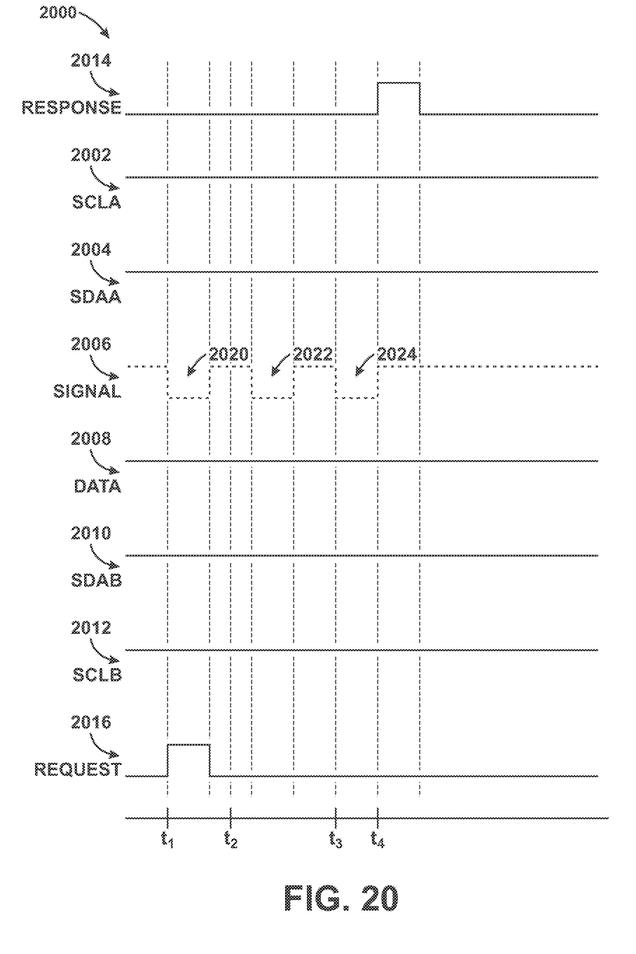

Referring to FIG. 20, an example timing diagram 2000 illustrating a slave-initiated communication in a bus interconnect utilizing the bus adapter devices 300 is illustrated in accordance with at least one embodiment of the present disclosure. In the timing diagram 2000, the SCLA signal 2002 represents the signaling at the SCL line 120, the SDAA signal 2004 represents the signaling at the SDA line 118, the signal 2006 represents the signaling at the signal line 128, the data signal 2008 represents the signaling at the data line 126, the SDAB signal 2010 represents the signaling at the SDA line 122 and the SCLB signal 2012 represents the signaling at the SCL line 124. For ease of illustration, slave initiated communication process is described in the bus interconnect context of FIGS. 2 and 3 and it is assumed that the bus adapter device 114 is the master-type bus adapter device and the bus adapter device 116 is the slave-type bus adapter device, and the bus adapter device 114 and the bus adapter device 116 implement permanent master and slave configurations, respectively, until a power off or other reset event. Further, in the timing diagram 2000, signaling represented by a dashed line represents signaling initiated by the bus adapter device 116 (as a slave-type bus adapter device).

The bus adapter device 114, as the master-type bus adapter device, typically initiates communications with the bus adapter device 116. However in certain implementations, it may be advantageous to facilitate the initiation of communications by the bus adapter device 116. The timing diagram 2000 illustrates an example technique.

In an idle condition, the bus adapter device 114 drives the data line 126 high and the bus adapter device 116 drives the signal line 128 high. To initiate a communication, a request signal 2016 is pulsed at time t1. The request signal 2016 can be generated by the bus adapter device 116 in response to, for example, the loss of PLL lock or the loss of EMI encoding synchronization at the bus adapter device 116, and the like. In response to the pulse in the request signal 2016 at time t1, the bus adapter device 116 generates a sequence of N low pulses on the signal line 128. In the illustrated example, the bus adapter device 116 generates a sequence of three (N=3) low pulses, pulses 2020, 2022, and 2024, at times t1, t2, and t3, respectively. In at least one embodiment, the pulses have a duration sufficient to be detected by the bus adapter device 114.

In response to detecting the predetermined number N of low pulses on the signal line 128 while in an idle state (using, e.g., a counter at the adapter control module 302, FIG. 3), the bus adapter device 114 asserts the response signal 2014 at time t4, thereby providing an acknowledgment to the bus adapter device that the request has been received. The assertion of the response signal 2014 can serve as, for example, a resynchronization used by the bus adapter device 116 to resynchronize with the bus adapter device 114. Although the request signal 2016 and the response signal 2014 are illustrated as transmitting only a single bit, in other embodiments, the request signal 2016, the response signal 2014, or both, can be used to transmit multiple bits. In the event that the source device 102 initiates a transaction during this sequence by driving its SDA line low, the bus adapter device 114 drives the data line 126 low and the bus adapter device 116 terminates the attempted slave-initiated communication in response to detecting that the data line 126 has been driven low. The bus adapter device 116 then may restart the slave-initiated communication when the source-initiated transaction is completed.

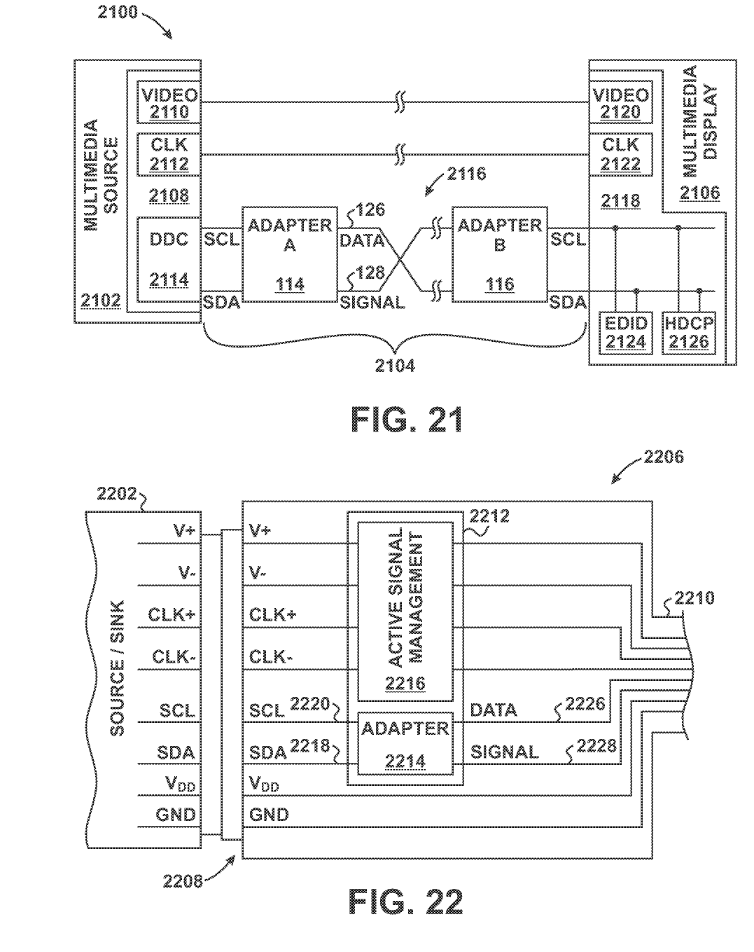

Referring to FIG. 21, an example multimedia transmission system 2100 utilizing the adaptive two-wire signaling techniques described herein is illustrated in accordance with at least one embodiment of the present disclosure. The multimedia transmission system 2100 includes a multimedia source device 2102 (analogous to the source device 102, FIG. 1), a two-wire bus interconnect 2104 (analogous to the two-wire bus interconnect 104/204, FIGS. 1 and 2), and a multimedia display device 2106 (analogous to the sink device 106, FIG. 1). The multimedia source 2102 can include any of a variety of sources of multimedia data, such as a set top box, a DVD player, and the like. The multimedia display device 2106 can include any of a variety of devices utilized to display or output multimedia data, such as, for example, a high-definition television, a computer display, and the like. The two-wire bus interconnect 2104 can include any of a variety of bus interconnects utilized to transmit video, audio, and other multimedia information between a multimedia source device and a multimedia display device. For ease of discussion, the two-wire bus interconnect 2104 is described herein in the context of the DVI/HDMI specifications.

The multimedia source device 2102 includes a DVI/HDMI interface 2108 to provide video, clock and control information to the multimedia display device 2106 and to obtain control information from the multimedia display device 2106. The DVI/HDMI interface 2108 therefore includes one or more ports 2110 to transmit video information and a port 2112 to transmit a pixel clock (e.g., as transition-minimized differential signaling), and a display data channel (DDC) module 2114 to communicate control information between the multimedia source device 2102 and the multimedia display device 2106 via the two-wire bus interconnect 2104. The control information can include, for example, extended display information data (EDID) and/or high-bandwidth digital copyright protection (HDCP) data communicated to or from the multimedia display device 2106. In at least one embodiment, the DDC module 214 acts as the master device for a two-wire bus 2116 of the two-wire bus interconnect 2104.

The multimedia display device 2102 includes a DVI/HDMI interface 2118 to receive video information via one or more ports 2120 and the pixel clock 2120 via a port 2122. The DVI/HDMI interface 2118 further includes an EDID module 2124 and an HDCP module 2126 that act as slave devices for the two-wire bus 2116. The EDID module 2124 is configured to provide EDID information to the DDC module 2114 in response to read operations to the EDID module 2124 initiated by the DDC module 214 via the two-wire bus 2116 and the HDCP module 2124 is configured to receive HDCP information from the DDC module 2114 and provide HDCP information to the DDC module 214 in response to write operations and read operations, respectively, initiated via the two-wire bus 2116.

In at least one embodiment, the DVI/HDMI interface 2108 and the DVI/HDMI interface 2118 are configured to interface with an I2C-based bus interconnect, as is provided by the DVI and HDMI specifications. However, due to the potential lengths of the two-wire bus, the use of a conventional I2C bus using open-terminal-based signaling across the entire length of the two-wire bus can result in signal degradation sufficient to prevent the DDC module 2114 from obtaining accurate EDID information and HDCP information, thereby resulting in a significant degradation in the display quality of the multimedia data transmitted in the multimedia transmission system 2100. To illustrate, even though a display device may be able to support a high resolution display, such as 1080 p, many multimedia source devices are configured to default to a low resolution standard, e.g., 720 p, when they are unable to successfully ascertain the maximum resolution supported by a display device due to a failure to accurately obtain EDID information via the I2C-based bus used for low-speed data transmissions.

In order to improve signal fidelity, and thus facilitate the successful transmission of EDID and HDCP information, the two-wire bus 2116 can implement the bus adapter devices 114 and 116 at the source-end and the sink-end, respectively, as described above. Due to the conversion from open-terminal-based signaling to push-pull-based signaling and back to open-terminal-based signaling, the two-wire bus 2116 can improve signal fidelity over greater interconnect lengths while being compatible with the I2C standard and other open-terminal-based standards at the source and sink ends.

In one embodiment, the two-wire bus interconnect 2104 can be implemented as a cable apparatus that connects the multimedia source device 2102 and the multimedia display device 2106. The cable apparatus can include a cable (e.g., a DVI-compatible cable or an HDMI-compatible cable) having the bus adapter devices 114 and 116 implemented at respective ends of the cable. Alternately, the cable apparatus can include a passive cable (e.g., a conventional HDMI or DVI cable) with cable adapters at both ends, whereby one cable adapter implements the bus adapter device 114 and the other cable adapter implements the bus adapter device 116. Alternately, one or both of the bus adapter devices 114 and 116 can be implemented at the bus interface of the multimedia source device 2102 or the multimedia display device 2106, respectively. In yet other embodiments, various combinations of the bus adapter devices implemented at an end of a cable, at a cable adapter, and at the interface of the source or sink device can be utilized. Cable-based implementations of the bus adapter devices are illustrated herein with reference to FIGS. 22-25.

Referring to FIG. 22, an implementation of a two-wire bus adapter device in a cable assembly is illustrated in accordance with at least one embodiment of the present disclosure. In the depicted example, a device interface 2202 of a source device or sink device is connected to another device interface (not shown) via a cable 2206. For ease of illustration, the cable 2206 is described in the context of a DVI/HDMI cable. The cable 2206 includes a cable receptacle 208 configured to electrically and mechanically connect to the device interface 202, whereby the cable receptacle 208 is electrically connected via conductive interconnects of a cable body 2210 of the cable 2206. Disposed at the cable receptacle 208 is active circuitry 2212, which includes a two-wire bus adapter device 2214 (e.g., bus adapter device 300). The active circuitry 2212 further can include active signal management circuitry 2216. The active circuitry 2212 can be implemented as one or more integrated circuits, such as, for example, an application specific integrated circuit (ASIC) or programmable logic (e.g., a field programmable gate array or FPGA). In one embodiment, the cable body 2210 can include, for example, several instances of twisted pairs enveloped in a shield of mylar or aluminum foil with a drain wire, in which the aggregate body of twisted pairs are grouped and embedded in a jacket which is covered with a coaxial shield, which can include copper, aluminum, nickel, steel or other conducting materials. In other embodiments, the cable body 2210 can include one or more twin-axial (twinax) cable bodies, or unshielded twisted pairs (UTP).

For ease of illustration, the high-speed data/pixel clock signals transmitted via the cable 2206 include one or more video data signals represented by signal V⁺ and its complement signal V⁻ and a pixel clock signal represented by signal CLK⁺ and its complement signal CLK⁻. Likewise, the device interface 2202 includes a SDA line 2218 and an SCL line 2220 for transmitting low-speed data in accordance with the I2C standard, a voltage reference signal V_{dd} and a voltage reference signal GND. Although this particular combination of digital signals is illustrated for ease of discussion, it will be appreciated that the techniques described herein can be utilized for any number or signaling-type of digital signals using the guidelines provided herein.

The bus adapter device 2214, in one embodiment, is configured to convert between the open-terminal-based signaling for the SDA line 2218 and the SCL line 2220 and the push-pull-based signaling of the corresponding data line 2226 (e.g., data line 126, FIG. 1) and signal line 2228 (e.g., data line 128, FIG. 1) of the plurality of conductors of the cable body 2210 that connect the two ends of the cable 2206 in accordance with the techniques described above with reference to FIGS. 1-20.

In the depicted example, the active signal management circuitry 2216 performs one or more active signal management processes on the video and pixel clock signals as described in U.S. patent application Ser. No. 11/519,192, filed on Sep. 11, 2006 and entitled “Active Signal Management in Cables and Other Interconnects,” the entirety of which is incorporated by reference herein. The one or more active signal management processes performed by the active signal management circuitry 2216 on a digital signal can include, but are not limited to, quasi-to-true differential signaling conversion, signal encoding using a noise source, skew management, passive equalization, clock encoding, encryption (e.g., using a data encryption standard (DES), pretty good privacy (PGP) encryption process, elliptical curve algorithms, hash tables or other entropy management or diffusion techniques as appropriate), deserialization and reserialization, periodic symbol encoding, and combinations thereof. The corresponding active signal management process at the receive end so as to recover the original digital signal therefore can include true-to-quasi differential signaling conversion, signal decoding, clock decoding, periodic symbol decoding, skew alignment, decryption, and combinations thereof.

In one embodiment, the active circuitry 2212 is powered by the voltage reference signals transmitted via the cable 2206. However, in certain instances, the device interface 2202 may be unable to source sufficient current or voltage to adequately power the active circuitry 2212. In this instance, the cable 2206 can include a power interface (not shown) to receive adequate power. The power interface can include, for example, a USB interface, a voltage interface to an ADC converter that connects to a standard 115 VAC wall outlet, and the like.

The implementation of the two-wire adaptive circuitry 2214 at one or both cable receptacles 2208 of the cable 2206 provides a number of benefits. In many instances, it may be infeasible to implement the two-wire adaptive circuitry at the source device or the sink device due to cost considerations or compatibility issues. Accordingly, the implementation of the two-wire adaptive circuitry within the cable 2206 itself allows the cable 2206 to be compatible with both the source device and the destination device while still providing for improved signal fidelity for digital signals transmitted via the cable 2206. In other instances, two-wire adaptive circuitry may be implemented at one of the source device and the destination device, but not the other. In this case, the implementation of the corresponding two-wire adaptive circuitry at the other end of the cable 2206 can permit or otherwise facilitate the use of two-wire adaptation process.

To illustrate, assume that the source device employs two-wire adaptive circuitry at its cable interface while the sink device does not have two-wire adaptive circuitry at its cable interface. The sink device, lacking two-wire adaptive circuitry, would be unable to recover the original signal from the altered signal, which would result in an incompatibility between the source device and the sink device. However, if the source device and the sink device were connected using a cable assembly having the two-wire adaptive circuitry at the cable receptacle connected to the sink device, the two-wire adaptive process could be applied by the source device to generate a processed digital signal and the two-wire adaptive circuitry at the cable receptacle at the sink end could receive the processed signal and perform one or more corresponding two-wire adaptive processes to recover the original data and provide the recovered data to the sink device.

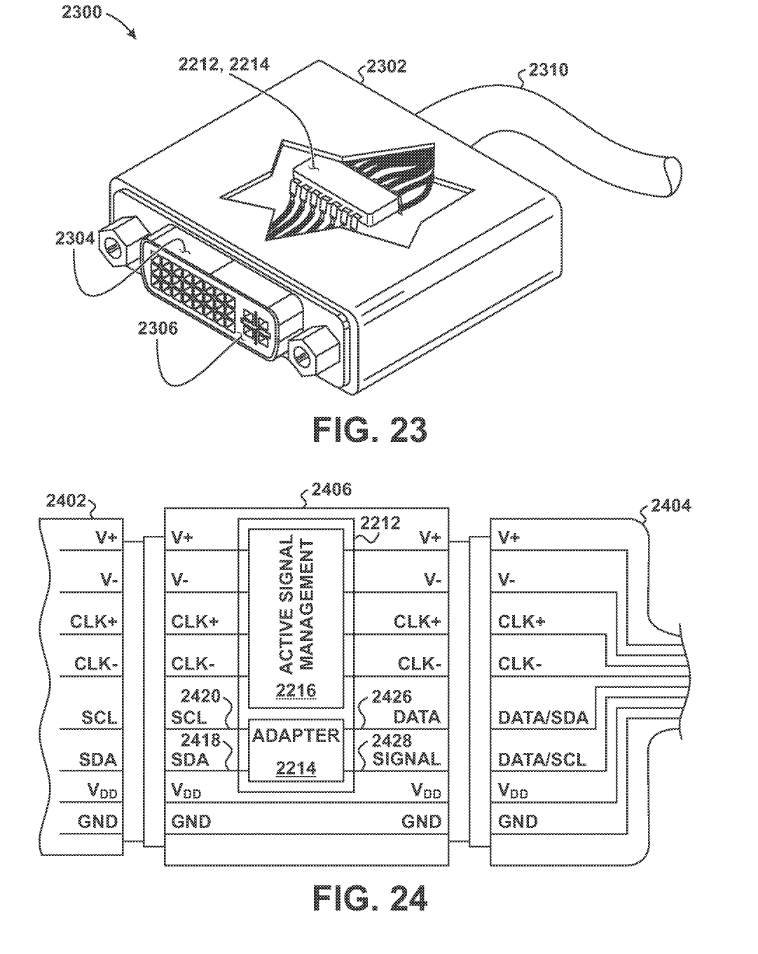

Referring to FIG. 23, a plan view of a cable receptacle 2300 of a cable assembly is illustrated in accordance with at least one embodiment of the present disclosure. The cable receptacle 2300 represents, for example, the cable receptacle 2208 of the cable 2206 (FIG. 22). The depicted example of FIG. 23 illustrates a cable receptacle compatible with a DVI cable interface. However, it will be appreciated that the cable receptacle 2300 can be configured to be compatible with any of a variety of cable interfaces, such as an HDMI cable interface, a DisplayPort interface, a UDI cable interface, an SMB cable interface, and the like.

The cable receptacle 2300 includes a housing 2302 fixed to a cable body 2310, whereby the active circuitry 2212, including the two-wire adaptive circuitry 2214, is disposed within the housing 2302. For purposes of illustration, active circuitry 2212 is illustrated as a single IC, such as an ASIC or FPGA, within the housing 2302. However, it will be appreciated that the active circuitry 2212 can be implemented as multiple discrete circuit devices. The cable receptacle 2300 further includes a receptacle interface 2304 that is removably attachable to a DVI cable interface of the source device or a DVI cable interface of the sink device. The receptacle interface 2304 can be attached to the DVI interface of a corresponding device via mechanical friction between the receptacle interface 2304 and the corresponding receptacle of the DVI interface, via clamps, screws or other mechanical fastening means, and the like.

Disposed at the external face of the receptacle interface 2304 is a pin interface 2306 configured to provide electrical connections between the device-side pins (male or female) of the active circuitry 2212 and the corresponding pins of the DVI interface of the device to which the cable receptacle 2302 is removably attached. In the example of FIG. 23, the pin interface 2306 represents a DVI-D female dual link pin interface. The cable-side pins of the active circuitry 2212 are connected to corresponding conductive interconnects (e.g., wiring) extending from the cable receptacle 2300 along the cable body 2310 to the other cable receptacle. As noted above, these conductive interconnects can be configured in twisted pair arrangements so as to reduce potential EMI emissions and signal distortion.

Referring to FIG. 24, an implementation of the two-wire adaptive circuitry in a cable adapter is illustrated in accordance with at least one embodiment of the present disclosure. In many instances, it may be difficult to implement the two-wire adaptive circuitry in at the source device and the sink device or entirely in a cable as illustrated by FIGS. 22 and 23. For example, a user may have previously purchased a conventional DVD player and a conventional HDTV and paid an installer a considerable sum of money to have a passive cable installed behind the walls and ceiling of a home theatre to connect the DVD player and the HDTV. Thus, the replacement of the conventional DVD player and the HDTV with new devices that implement the two-wire adaptation techniques described herein may be cost prohibitive, as may be the removal and replacement of the passive cable with an active cable interconnect utilizing two-wire adaptive circuitry as described herein. Accordingly, in one embodiment, one or more cable adapters may be used at either end of a passive cable to provide active signal management for signals transmitted via the passive cable.

In the depicted example, a device interface 2402 is connected to a conventional passive cable 2404 (e.g., a standard DVI cable) via a cable adapter 2406. The transmit-side cable adapter 408 incorporates the active circuitry 2212, including the two-wire adaptive circuitry 2214 for signal conversion between an SDA line 2418 (e.g., SDA line 118 or SDA line 122, FIG. 1) and an SCL line 2420 (e.g., SCL line 120 or SCL line 124, FIG. 1) and a data line 2426 (e.g., data line 126, FIG. 1) and a signal line 2428 (e.g., signal line 128, FIG. 1) using the techniques described above with reference to FIGS. 1-20.

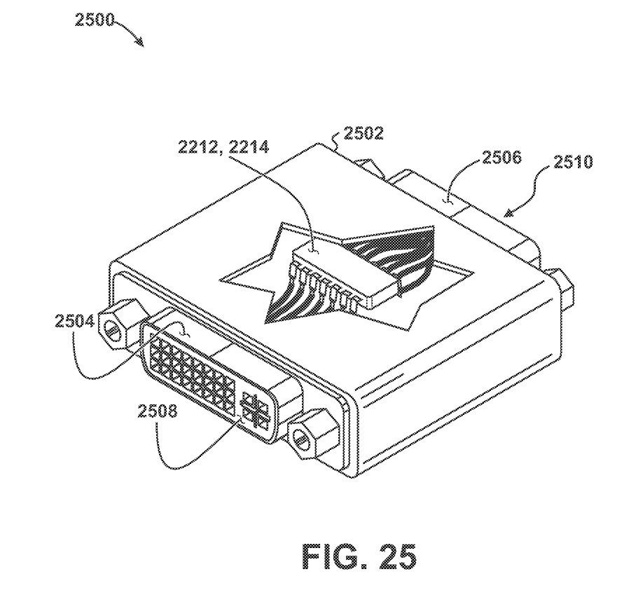

Referring to FIG. 25, a plan view of a cable adapter 2500 incorporating two-wire adaptive circuitry is illustrated in accordance with at least one embodiment of the present disclosure. The cable adapter 2500 can represent, for example, the cable adapters 2406 of FIG. 24. The depicted example of FIG. 25 illustrates a cable adapter 2500 compatible with a DVI cable interface. However, it will be appreciated that the cable adapter 2500 can be configured to be compatible with any of a variety of cable interfaces, such as an HDMI cable interface, a DisplayPort interface, a UDI cable interface, an SMB interface, and the like.

The cable adapter 2500 includes a housing 2502 in which the active circuitry 2212, including the two-wire adaptive circuitry 2214, is disposed. The cable adapter 2500 further includes receptacle interfaces 2504 and 2506 that are removably attachable to the DVI interface of the source device or the sink device and the receptacle interface of the corresponding cable receptacle of the conventional passive cable 2404 (FIG. 24). Disposed at the external face of the receptacle interface 2504 is a pin interface 2508 configured to provide electrical connections between the device interface and the device-side pins (male or female) of the active signal management circuitry of the cable adapter 2500. Likewise, disposed at the external face of the receptacle interface 2506 is a pin interface 2510 configured to provide electrical connections between the receptacle interface of the corresponding cable receptacle and the cable-side pins (male or female) of the active circuitry 2212 of the cable adapter 2500. To illustrate, assuming that the source device interface and the destination device interface are DVI-D dual link female interfaces and, consequently, the receptacle interfaces of both ends of the conventional passive cable 2404 are DVI-D dual link male interfaces, the receptacle interface 2504 and pin interface 2508 would be a DVI-D dual link male interface to connect to the DVI-D dual link female interface of the source/sink device, while the receptacle interface 2506 and the pin interface 2510 would be a DVI-D dual link female interface to connect to the DVI-D dual link male interface of the corresponding cable receptacle of the conventional passive cable 2404. The receptacle interfaces 2504 and 2506 can be attached to the DVI interface of a corresponding device via mechanical friction, via clamps, screws or other mechanical fastening means, and the like.

As illustrated by FIGS. 22-25, it can be advantageous to incorporate the bus adapter circuitry into a cable or into a cable adapter at one or both ends of a cable interconnect. FIGS. 22-25 illustrate a particular implementation whereby the bus adapter circuitry is incorporated at one or both ends of the cable or in a cable adapter connected to the one end of the cable, while the active signal management receive circuitry 110 is incorporated at the other end of the cable or in a cable adapter connected to the other end of the cable. In such instances, it will be appreciated that the cable or cable adapter is unidirectional, i.e., each cable receptacle is specific to only to the transmit side of the receive side. An installer or user therefore would need to ensure that the cable or the cable adapter is connected in the proper orientation. In order to reduce the reliance on ensuring the proper connection orientation, in at least one embodiment, the bus adapter devices can be implemented in a cable assembly such that the bus adapter devices at both ends of the cable assembly are interchangeable so as to allow either cable end to be connected to either a source device or a sink device, thereby facilitating ease of installation.

In this document, relational terms such as “first” and “second”, and the like, may be used solely to distinguish one entity or action from another entity or action without necessarily requiring or implying any actual such relationship or order between such entities or actions. The terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

The term “another”, as used herein, is defined as at least a second or more. The terms “including”, “having”, or any variation thereof, as used herein, are defined as comprising. The term “coupled”, as used herein with reference to electro-optical technology, is defined as connected, although not necessarily directly, and not necessarily mechanically.

The terms “assert,” “set,” “negate,” “deassert,” “clear,” “drive,” or “pull” are used when referring to the rendering of a signal, a conductor, or similar apparatus into a particular state. If the logically true state is a high logic high level, the logically false state is a low logic level, or vice versa. Likewise, although the preceding description makes reference to “low” and “high” states for signaling in particular arrangements, it will be appreciated that the arrangement may be reversed as appropriate.

Other embodiments, uses, and advantages of the disclosure will be apparent to those skilled in the art from consideration of the specification and practice of the disclosure disclosed herein. The specification and drawings should be considered example only, and the scope of the disclosure is accordingly intended to be limited only by the following claims and equivalents thereof.

What is claimed is:

1. An apparatus comprising:
a first bus interface comprising a first open-terminal port coupleable a first line of a first two-wire bus and a second open-terminal port coupleable to a second line of the first two-wire bus;
a second bus interface comprising a first push-pull port coupleable to a first line of a second two-wire bus and a second push-pull port coupleable to a second line of the second two-wire bus; and
control logic to modify a state of the second line of the first two-wire bus via the second open-terminal port based on handshake information received via the second push-pull port in a first mode.

2. The apparatus of claim 1, wherein the control logic is to modify a state of the second line of the first two-wire bus by:
driving the second line of the first two-wire bus to a first state via the second open-terminal port;
receiving a first handshake indicator via the second push-pull port while driving the second line of the first two-wire bus to the first state; and
releasing the second line of the first two-wire bus in response to receiving the first handshake indicator.

3. The apparatus of claim 2, wherein the control logic is to drive the second line of the first two-wire bus to the first state in response to detecting a transition of the second line of the first two-wire bus to a second state prior to receiving the first handshake indicator.

4. The apparatus of claim 2, wherein the control logic is to drive the second line of the first two-wire bus to the first state in response to receiving a second handshake indicator via the second push-pull port prior to receiving the first handshake indicator.

5. The apparatus of claim 1, wherein the control logic is to modify a state of the second line of the first two-wire bus by:
receiving a first handshake indicator via the second push-pull port; and
driving the second line of the first two-wire bus to a select state via the second open-terminal port in response to receiving the first handshake indicator.

6. The apparatus of claim 1, wherein the control logic is to transmit handshake information via the second push-pull port based on clock information received via the second line of the first two-wire bus.

7. The apparatus of claim 6, wherein the control logic is to transmit handshake information by transmitting a handshake indicator via the second push-pull port in response to detecting a transition of the second line of the first two-wire bus from a first state to a second state.

8. The apparatus of claim 6, wherein the control logic is to transmit handshake information by:
receiving a first handshake indicator via the second push-pull port;
determining whether the second line of the first two-wire bus is at a select state; and
transmitting a second handshake indicator via the second push-pull port in response to both receiving the first handshake indicator and determining the second line of the first two-wire bus is at the select state.

9. The apparatus of claim 6, wherein the control logic is to transmit handshake information by:
driving the second line of the first two-wire bus to a first state via the second open-terminal port;
receiving a first handshake indicator via the second line of the second two-wire bus while driving the second line of the first two-wire bus;
releasing the second line of the first two-wire bus in response to receiving the first handshake indicator;
detecting a transition of the second line of the first two-wire bus from the first state to a second state subsequent to releasing the second line of the first two-wire bus; and
transmitting a second handshake indicator via the second line of the second two-wire bus in response to detecting the transition of the second line.

10. The apparatus of claim 6, wherein the control logic is to transmit the handshake information by:
receiving a first handshake indicator via the second push-pull port; and
transmitting a second handshake indicator via the second push-pull port in response to both receiving the first handshake indicator and determining that at least a predetermined duration has lapsed.

11. The apparatus of claim 1, wherein the control logic is to transmit a clock signal received at the second line of the first two-wire bus to the second line of the second two-wire bus in a second mode.

12. The apparatus of claim 1, wherein the control logic is to:
transmit a clock signal received at the second line of the second two-wire bus to the second line of the first two-wire bus in a second mode.

13. An apparatus comprising:
a first bus interface comprising a first open-terminal port coupleable a first line of a first two-wire bus and a second open-terminal port coupleable to a second line of the first two-wire bus;
a second bus interface comprising a first push-pull port coupleable to a first line of a second two-wire bus and a second push-pull port coupleable to a second line of the second two-wire bus; and
control logic to transmit handshake information via the second push-pull port based on clock information received via the second open-terminal port.

14. The apparatus of claim 13, wherein the control logic is to transmit handshake information by transmitting a handshake indicator via the second push-pull port in response to detecting a transition of the second line of the first two-wire bus from a first state to a second state.

15. The apparatus of claim 13, wherein the control logic is to transmit handshake information by:
receiving a first handshake indicator via the second push-pull port;
determining whether the second line of the first two-wire bus is at a select state; and
transmitting a second handshake indicator via the second push-pull port in response to both receiving the first handshake indicator and determining the second line of the first two-wire bus is at the select state.

16. The apparatus of claim 13, wherein the control logic is to transmit handshake information by:
driving the second line of the first two-wire bus to a first state via the first open-terminal port;
receiving a first handshake indicator via the second push-pull port while driving the second line of the first two-wire bus;
releasing the second line of the first two-wire bus in response to receiving the first handshake indicator;
detecting a transition of the second line of the first two-wire bus from the first state to a second state subsequent to releasing the second line of the first two-wire bus; and
transmitting a second handshake indicator via the second push-pull port in response to detecting the transition of the second line.

17. The apparatus of claim 13, wherein the control logic is to transmit handshake information by:
receiving a first handshake indicator via the second push-pull port; and
transmitting a second handshake indicator via the second push-pull port in response to both receiving the first handshake indicator and determining that at least a predetermined duration has lapsed.

18. In an apparatus comprising a first open-terminal port coupled to a first line of a first two-wire bus, a second open-terminal port coupled to a second line of the first two-wire bus, a first push-pull port coupled to a first line of a second two-wire bus, and a second push-pull port coupled to a second line of the second two-wire bus, a method comprising:
modifying a state of the second line of the first two-wire bus via the second open-terminal port based on handshake information received via the second push-pull port.

19. The method of claim 18, wherein modifying a state of the second line of the first two-wire bus comprises:
driving the second line of the first two-wire bus to a first state via the second open-terminal port;
receiving a handshake indicator via the second push-pull port while driving the second line of the first two-wire bus to the first state; and
releasing the second line of the first two-wire bus in response to receiving the handshake indicator.

20. The method of claim 18, wherein modifying a state of the second line of the first two-wire bus comprises:
receiving a first handshake indicator via the second push-pull port;
driving the second line of the first two-wire bus to a select state via the second open-terminal port; and
transmitting a second handshake indicator via the second push-pull port a predetermined duration after driving the second line of the first two-wire bus to the select state.

21. In an apparatus comprising a first open-terminal port coupled to a first line of a first two-wire bus, a second open-terminal port coupled to a second line of the first two-wire bus, a first push-pull port coupled to a first line of a second two-wire bus, and a second push-pull port coupled to a second line of the second two-wire bus, a method comprising:
transmitting handshake information via the second push-pull port based on clock information received via the second open-terminal port.

22. The method of claim 21, wherein transmitting handshake information comprises transmitting a handshake indicator via the second push-pull port in response to detecting a transition of the first line of the first two-wire bus from a first state to a second state.

23. The method of claim 21, wherein transmitting handshake information comprises:
receiving a first handshake indicator via the second push-pull port;
determining whether the second line of the first two-wire bus is at a select state; and
transmitting a second handshake indicator via the second push-pull port in response to both receiving the first handshake indicator and determining the second line of the first two-wire bus is at the select state.

24. The method of claim 21, wherein transmitting handshake information comprises:
driving the second line of the first two-wire bus to a first state via the first open-terminal port;
receiving a first handshake indicator via the second push-pull port while driving the second line of the first two-wire bus;
releasing the second line of the first two-wire bus in response to receiving the first handshake indicator;
detecting a transition of the second line of the first two-wire bus from the first state to a second state subsequent to releasing the second line of the first two-wire bus; and
transmitting a second handshake indicator via the second push-pull port in response to detecting the transition of the second line.

25. In an apparatus comprising a first bus adapter device and a second bus adapter device, the first bus adapter device comprising a first open-terminal port coupled to a first line of a first two-wire bus, a second open-terminal port coupled to a second line of the first two-wire bus, a first push-pull port coupled to a first line of a second two-wire bus, and a second push-pull port coupled to a second line of the second two-wire bus, and the second bus adapter device comprising a third open-terminal port coupled to a first line of a third two-wire bus, a fourth open-terminal port coupled to a second line of the third two-wire bus, a third push-pull port coupled to the first line of the second two-wire bus, and a fourth push-pull port coupled to the second line of the second two-wire bus, a method comprising:
driving, via the fourth open-terminal port, the second line of the third two-wire bus to a first state;
transmitting, via the second push-pull port, a first handshake indicator in response to detecting, via the second open-terminal port, a transition of the second line of the first two-wire bus from a first state to a second state;
releasing the second line of the third two-wire bus in response to receiving the first handshake indicator via the fourth push-pull port;
transmitting, via the fourth push-pull port, a second handshake indicator in response to detecting, via the fourth open-terminal port, a transition of the second line of the third two-wire bus from the first state to the second state subsequent to releasing the second line of the third two-wire bus;
driving, via the second open-terminal port, the second line of the first two-wire bus to the first state in response to detecting a transition of the second line of the first two-wire bus from the second state to the first state;
transmitting, via the second push-pull port, a third handshake indicator in response to receiving, via the second push-pull port, the second handshake indicator and in response to detecting, via the second open-terminal port, the second line of the first two-wire bus is at the first state;
driving, via the fourth open-terminal port, the second line of the third two-wire bus to the first state in response to receiving, via the fourth push-pull port, the third handshake indicator;
transmitting, via the fourth push-pull port, a fourth handshake indicator in response to a lapse of a predetermined duration subsequent to receiving the third handshake indicator; and
releasing the second line of the first two-wire bus in response to receiving, via the second push-pull port, the fourth handshake indicator.
